(19) United States
(12) Patent Application Publication
(10) Pub. No.: US 2026/0046729 A1
(43) Pub. Date: Feb. 12, 2026

(54) HANDOVER-AWARE PROACTIVE TRAFFIC SCHEDULING

(71) Applicant: Dell Products L.P., Round Rock, TX (US)

(72) Inventor: Ali Esswie, Calgary (CA)

(21) Appl. No.: 18/801,388

(22) Filed: Aug. 12, 2024

(51) Int. Cl. H04W 36/22; H04W 36/00; H04W 36/30

(52) U.S. Cl. CPC H04W 36/22; H04W 36/008355; H04W 36/305

(57) ABSTRACT

A user equipment may receive, from a serving radio network node, handover prediction configuration information indicative of at least one handover prediction criterion. A learning model executed by the user equipment may determine, based on the at least one handover prediction criterion, at least one handover event prediction and a confidence level corresponding to the learning model. The user equipment may adjust a time criterion of the at least one handover prediction criterion if the confidence level does not satisfy a confidence level criterion of the at least one handover prediction criterion. Based on the adjusted time handover prediction criterion, the learning model may determine an updated handover event prediction and an updated confidence level that satisfies the confidence level criterion and may report the updated prediction to the node. The node may adjust scheduling of delivery of traffic directed to the user equipment based on the updated prediction.

### REFERENCE TO RELATED APPLICATIONS

The subject patent application is related to U.S. patent application Ser. No. ______, filed ______, and entitled “TIME-BOUND DYNAMIC DEVICE HANDOVER EVENT REPORTING” (docket no. 139598.01/DELLP1302US), the entirety of which application is hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose, on a given RAN resource, loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a radio network node comprising at least one processor, receiving, from at least one user equipment, at least one user equipment handover prediction report indicative of at least one user equipment handover prediction. Based on the at least one user equipment handover prediction, the method may further comprise determining, by the radio network node, pending traffic, associated with a communication session corresponding to the at least one user equipment, that is capable of being delivered, by the radio network node with respect to the at least one user equipment according to the at least one user equipment handover prediction, to result in determined pending traffic. The method may further comprise facilitating, by the radio network node, delivering the determined pending traffic with respect to the at least one user equipment.

The at least one user equipment handover prediction may be indicative of at least one predicted handover time, predicted by the at least one user equipment, with respect to which a communication link between the at least one user equipment and the radio network node is threshold likely to fail.

In an example embodiment, the method may further comprise facilitating, by the radio network node, receiving, from the at least one user equipment, at least one user equipment handover prediction capability indication indicative of at least one user equipment handover prediction capability.

In an example embodiment, responsive to the receiving of the at least one user equipment handover prediction capability indication, the method may further comprise facilitating, by the radio network node, transmitting, to the at least one user equipment, user equipment handover prediction configuration information indicative of at least one user equipment handover prediction reporting criterion.

The user equipment handover prediction configuration information may comprise at least one of: at least one handover prediction learning model confidence level criterion to be usable by the at least one user equipment to determine whether to transmit the at least one user equipment handover prediction report; or at least one preferred handover prediction reporting time indication indicative of at least one time with respect to which transmitting of the at least one user equipment handover prediction report is to be performed.

The at least one user equipment handover prediction may be indicative of at least one predicted handover time, predicted by the at least one user equipment, with respect to which a communication link between the at least one user equipment and the radio network node is threshold likely to fail. The at least one predicted handover time may be earlier, or sooner, than the at least one time.

In an example embodiment, the determining of the determined pending traffic may comprise analyzing at least one predicted handover time, indicated by the at least one user equipment handover prediction and with respect to which a communication link between the at least one user equipment and the radio network node is threshold likely to fail, with respect to at least one remaining latency budget associated with the pending traffic, to result in at least one analyzed predicted handover time and determining that the at least one analyzed predicted handover time occurs after at least one scheduled delivery time with respect to which at least a portion of the pending traffic has been scheduled to be delivered. The facilitating of the delivering of the determined pending traffic with respect to the at least one user equipment may comprise, based on the at least one analyzed predicted handover time being determined to occur after the at least one scheduled delivery time, facilitating the delivering of the determined pending traffic with respect to the at least one user equipment before the at least one predicted handover time.

In an example embodiment, the at least one scheduled delivery time may be at least one first scheduled delivery time. The method may further comprise determining, by the radio network node, a second scheduled delivery time that occurs earlier than the at least one first scheduled delivery time. The facilitating of the delivering of the determined pending traffic with respect to the at least one user equipment before the at least one predicted handover time may comprise facilitating the delivering of the determined pending traffic with respect to the at least one user equipment at least as early as the second scheduled delivery time.

In an example embodiment, the determining of the determined pending traffic may comprise analyzing the at least one predicted handover time, indicated by the at least one user equipment handover prediction and with respect to which a communication link between the at least one user equipment and the radio network node is threshold likely to fail, with respect to at least one remaining latency budget associated with the pending traffic, to result in at least one analyzed predicted handover time and determining that the at least one analyzed predicted handover time occurs before at least one scheduled delivery time with respect to which at least a portion of the pending traffic has been scheduled to be delivered. The facilitating of the delivering of the determined pending traffic with respect to the at least one user equipment may comprise, based on the at least one analyzed predicted handover time being determined to occur earlier than the at least one scheduled delivery time, facilitating the delivering of the determined pending traffic with respect to the at least one user equipment before the at least one predicted handover time.

In an example embodiment, the radio network node may be a serving radio network node. The at least one user equipment handover prediction report may be further indicative of at least one target radio network node, determined by the at least one user equipment. The method may further comprise, after the delivering of the determined pending traffic with respect to the at least one user equipment, facilitating, by the serving radio network node, performing at least one handover operation corresponding to the at least one user equipment and with respect to the at least one target radio network node.

In another example embodiment, a radio network node, may comprise at least one processor configured to process executable instructions that, when executed by the at least one processor, may facilitate performance of operations that may comprise receiving, from at least one user equipment, at least one user equipment handover prediction capability indication indicative of at least one user equipment handover prediction capability. Responsive to the at least one user equipment handover prediction capability, The operations may further comprise determining user equipment handover prediction configuration information indicative of at least one user equipment handover prediction reporting criterion, transmitting, to the at least one user equipment, the user equipment handover prediction configuration information, and receiving, from the at least one user equipment, at least one user equipment handover prediction report indicative of at least one user equipment handover prediction, wherein the at least one user equipment handover prediction is determined by the at least one user equipment based on the user equipment handover prediction configuration information. Based on the at least one user equipment handover prediction, the operations may further comprise performing at least one traffic scheduling operation.

In an example embodiment, the performing of the at least one traffic scheduling operation may comprise determining at least one remaining delay budget associated with at least one protocol data unit corresponding to pending traffic to be directed to the at least one user equipment to result in at least one determined remaining delay budget, analyzing the at least one determined remaining delay budget with respect to the at least one user equipment handover prediction to result in at least one analyzed determined remaining delay budget, determining that the at least one analyzed determined remaining delay budget is associated with at least one remaining delay budget exhaustion time that occurs before at least one predicted handover time indicated by the at least one user equipment handover prediction, avoiding changing a current scheduling of delivery of the at least one protocol data unit.

In an example embodiment, the performing of the at least one traffic scheduling operation May comprise determining at least one remaining delay budget associated with at least one protocol data unit corresponding to pending traffic to be directed to the at least one user equipment to result in at least one determined remaining delay budget, analyzing the at least one determined remaining delay budget with respect to the at least one user equipment handover prediction to result in at least one analyzed determined remaining delay budget, determining that the at least one analyzed determined remaining delay budget is associated with at least one remaining delay budget exhaustion time that occurs before at least one predicted handover time indicated by the at least one user equipment handover prediction, and adjusting a current scheduling of delivery of the at least one protocol data unit to result in an adjusted scheduling of delivery of the at least one protocol data unit, wherein the adjusted scheduling corresponds to an earlier delivering of the at least one protocol data unit as compared to delivering the at least one protocol data unit according to the current scheduling.

In an example embodiment, the at least one user equipment handover prediction reporting criterion may comprise at least one preferred handover prediction reporting time indication indicative of at least one preferred handover prediction reporting time with respect to which the at least one user equipment is to transmit the at least one user equipment handover prediction report relative to the at least one predicted handover time indicated by the at least one user equipment handover prediction. A prediction reporting difference between a prediction receiving time corresponding to the receiving the at least one user equipment handover prediction report and the at least one predicted handover time may be smaller than the at least one preferred handover prediction reporting time.

In an example embodiment, the performing of the at least one traffic scheduling operation may comprise determining at least one scheduling of at least one protocol data unit corresponding to traffic to be directed to the at least one user equipment. The operations may further comprise delivering the traffic with respect to the at least one user equipment according to the at least one scheduling.

In yet another example embodiment, a non-transitory machine-readable medium may comprise executable instructions that, when executed by at least one processor of radio network equipment, may facilitate performance of operations that may comprise transmitting, to a user device, user device handover prediction configuration information that is based on at least one user device handover prediction capability and that comprises criterion information representative of at least one user device handover prediction reporting criterion, and receiving, from the user device, a user device handover prediction report indicative of a user device handover prediction, wherein the user device handover prediction is determined by the user device based on at least one user device handover prediction reporting criterion. Based on the user device handover prediction, the operations may further comprise performing at least one traffic scheduling operation.

In an example embodiment, the performing of the at least one traffic scheduling operation may comprise determining a remaining delay budget associated with a traffic packet to be directed to the user device to result in a determined remaining delay budget, analyzing the determined remaining delay budget with respect to the user device handover prediction to result in an analyzed determined remaining delay budget, determining that the analyzed determined remaining delay budget is associated with a remaining delay budget exhaustion time that will occur before a predicted handover time indicated by the user device handover prediction, and avoiding changing a current scheduling of delivery of the traffic packet.

In an example embodiment, the performing of the at least one traffic scheduling operation may comprise determining a remaining delay budget associated with a traffic packet to be directed to the user device to result in a determined remaining delay budget, analyzing the determined remaining delay budget with respect to the user device handover prediction to result in an analyzed determined remaining delay budget, determining that the analyzed determined remaining delay budget is associated with a remaining delay budget exhaustion time that will occur before a predicted handover time indicated by the user device handover prediction, and adjusting a current scheduling of delivery of the traffic packet to result in an adjusted scheduling of delivery of the traffic packet. The adjusted scheduling may correspond to delivering the traffic packet earlier than delivering the traffic packet according to the current scheduling.

In an example embodiment, the performing of the at least one traffic scheduling operation may comprise determining a remaining delay budget associated with a traffic packet to be directed to the user device to result in a determined remaining delay budget, analyzing the determined remaining delay budget with respect to the user device handover prediction to result in an analyzed determined remaining delay budget, and determining that the analyzed determined remaining delay budget is associated with a remaining delay budget exhaustion time that will occur after a predicted handover time indicated by the user device handover prediction. The operations may further comprise initiating handover of the user device to a target radio network node, and forwarding the traffic packet to the target radio network node for transmission thereby to the user device. The target radio network node may be indicated by the user device handover prediction report.

In another example embodiment, a method may comprise performing, by at least one user equipment comprising at least one processor, at least one user equipment handover prediction operation. Based on the at least one user equipment handover prediction operation, the method may fully comprise performing, by the at least one user equipment with respect to at least one serving radio network node, at least one user equipment handover operation.

In an example embodiment, the performing of the at least one user equipment handover operation may comprise transmitting, to the at least one serving radio network node, at least one user equipment handover prediction report indicative of at least one user equipment handover prediction.

In an example embodiment, the at least one user equipment handover prediction operation may comprise analyzing at least one prediction accuracy corresponding to at least one user equipment handover prediction to result in at least one analyzed user equipment handover prediction accuracy, and determining that the at least one analyzed user equipment handover prediction accuracy satisfies at least one user equipment handover prediction reporting criterion to result in at least one determined analyzed prediction accuracy. The performing of the at least one user equipment handover operation may comprise, based on the at least one determined analyzed prediction accuracy being determined to satisfy at least one user equipment handover prediction reporting criterion, transmitting, to the at least one serving radio network node, at least one user equipment handover prediction report indicative of the at least one user equipment handover prediction.

The method may further comprise receiving, by the at least one user equipment from the at least one serving radio network node, user equipment handover prediction configuration information indicative of the at least one user equipment handover prediction reporting criterion. The user equipment handover prediction configuration information may comprise at least one of: at least one handover prediction learning model confidence level criterion to be usable by the at least one user equipment to determine whether to transmit the at least one user equipment handover prediction report; or at least one specified handover prediction reporting time indication indicative of at least one time with respect to which transmitting of the at least one user equipment handover prediction report is to be performed. The method may further comprise determining, by the at least one user equipment, at least one radio parameter value corresponding to at least one radio parameter value to result in at least one determined radio parameter value, and applying, by the at least one user equipment, at least one handover prediction learning model to the at least one determined radio parameter value to facilitate determining the at least one user equipment handover prediction, wherein the at least one prediction accuracy comprises at least one confidence level corresponding to the at least one handover prediction learning model.

The user equipment handover prediction may comprise at least one user equipment handover prediction time value indication indicative of at least one user equipment handover prediction time relative to which at least one radio condition, corresponding to the at least one serving radio network node, with respect to the at least one user equipment may be predicted to correspond to at least one handover criterion being satisfied, and wherein the at least one user equipment handover prediction time may be determined by the at least one user equipment based on the at least one confidence level.

The at least one user equipment handover prediction time value indication may be indicative of at least one actual predicted user equipment handover prediction time. The transmitting of the at least one user equipment handover prediction report may be an actual transmitting of the at least one user equipment handover prediction report. The at least one specified handover prediction reporting time indication may be indicative of a specified reporting advance notification period corresponding to at least one future transmitting time corresponding to at least one future transmitting of at least one future user equipment handover prediction report with respect to at least one future predicted user equipment handover prediction time indicated by the at least one future user equipment handover prediction report. The at least one actual predicted user equipment handover prediction time may occur sooner relative to the actual transmitting of the at least one user equipment handover prediction report than the specified reporting advance notification period, which may be a preferred time between reporting of a predicted user equipment handover prediction and a start of a predicted handover prediction period, relative to the actual transmitting of the at least one user equipment handover prediction report.

In an example embodiment, the at least one user equipment handover operation may comprise transmitting, to the at least one serving radio network node, at least one user equipment handover prediction capability indication indicative of at least one user equipment handover prediction capability.

In an example embodiment, the method may further comprise determining, by the at least one user equipment, at least one handover capability parameter value corresponding to at least one handover capability parameter to result in at least one determined handover capability parameter, and analyzing, by the at least one user equipment, the at least one determined handover capability parameter with respect to at least one handover capability parameter criterion to result in at least one analyzed determined handover capability parameter value. The at least one user equipment handover prediction capability indication may be indicative that the at least one analyzed determined handover capability parameter value is determined to fail to satisfy the at least one handover capability parameter criterion. Based on the at least one analyzed determined handover capability parameter value being determined to fail to satisfy the at least one handover capability parameter criterion, the method may further comprise avoiding, by the at least one user equipment, determining at least one user equipment handover prediction. The at least one handover capability parameter may comprise at least one energy-related parameter. The at least one handover capability parameter value may comprise at least one energy-related parameter value corresponding to the at least one energy-related parameter.

In another example embodiment, a user equipment may comprise at least one processor that may be configured to process executable instructions that, when executed by the at least one processor, may facilitate performance of operations that may comprise receiving, from at least one serving radio network node, user equipment handover prediction configuration information indicative of at least one user equipment handover prediction reporting criterion, and determining at least one radio parameter value, with respect to the at least one serving radio network node, corresponding to at least one radio parameter value to result in at least one determined radio parameter value. Based on the at least one determined radio parameter value, the operations may further comprise determining at least one user equipment handover prediction, analyzing at least one prediction accuracy, corresponding to the at least one user equipment handover prediction, with respect to the at least one user equipment handover prediction reporting criterion to result in at least one analyzed user equipment handover prediction accuracy and determining that the at least one analyzed user equipment handover prediction accuracy satisfies the at least one user equipment handover prediction reporting criterion to result in at least one determined analyzed prediction accuracy. Based on the at least one determined analyzed prediction accuracy being determined to satisfy the at least one user equipment handover prediction reporting criterion, The operations may further comprise performing, with respect to the at least one serving radio network node, at least one user equipment handover operation.

In an example embodiment, the user equipment handover prediction configuration information may comprise at least one of: at least one handover prediction learning model confidence level criterion to be usable by the user equipment to determine to transmit, to the at least one serving radio network node, at least one user equipment handover prediction report; or at least one specified handover prediction reporting time indication indicative of at least one time with respect to which transmitting of the at least one user equipment handover prediction report is to be performed.

In an example embodiment, the performing of the at least one user equipment handover operation may comprise transmitting, to the at least one serving radio network node, at least one user equipment handover prediction report indicative of the at least one user equipment handover prediction.

In an example embodiment, the determining of the at least one user equipment handover prediction may comprises applying at least one handover prediction learning model to the at least one determined radio parameter value, wherein the at least one prediction accuracy comprises at least one confidence level corresponding to the at least one handover prediction learning model.

The user equipment handover prediction may comprise at least one user equipment handover prediction time value indication indicative of at least one user equipment handover prediction time at which at least one radio condition, corresponding to the at least one serving radio network node, with respect to the user equipment may be predicted to correspond to at least one user equipment handover criterion being satisfied. The at least one user equipment handover prediction time may be determined by the user equipment based on the at least one confidence level.

In yet another example embodiment, a non-transitory machine-readable medium may comprise executable instructions that, when executed by at least one processor of a user device, may facilitate performance of operations that may comprise determining at least one radio parameter value, with respect to at least one serving radio network node, corresponding to at least one radio parameter value to result in at least one determined radio parameter value. Based on the at least one determined radio parameter value, the operations may further comprise determining, using at least one handover prediction learning model and according to a first user device handover prediction reporting criterion, a first user device handover prediction. The operations may further comprise analyzing a first confidence level, corresponding to the at least one handover prediction learning model, with respect to a second user device handover prediction reporting criterion to result in a first analyzed user device handover prediction confidence level, and determining that the first analyzed user device handover prediction confidence level fails to satisfy the second user device handover prediction reporting criterion. Based on the first analyzed user device handover prediction confidence level being determined to fail to satisfy the second user device handover prediction reporting criterion, the operations may further comprise adjusting the first user device handover prediction reporting criterion to result in an adjusted first user device handover prediction reporting criterion. The first user device handover prediction reporting criterion may be a preferred handover prediction period time and the adjusted first user device handover prediction reporting criterion may result from the user device modifying a configured preferred handover prediction period time based on conditions present at the user equipment, for example a battery charge condition, such that the user equipment can predict a handover event with a configured confidence level without dangerously depleting a battery charge corresponding to a battery associated with the user device. The operations may further comprise updating the at least one handover prediction learning model according to the adjusted first user device handover prediction reporting criterion to result in at least one updated handover prediction learning model. Based on the at least one determined radio parameter value, the operations may further comprise determining, using the at least one updated handover prediction learning model and according to the adjusted first user device handover prediction reporting criterion, a second user device handover prediction. The operations may further comprise analyzing a second confidence level, corresponding to the at least one updated handover prediction learning model, with respect to the second user device handover prediction reporting criterion to result in a second analyzed user device handover prediction confidence level, and determining that the second analyzed user device handover prediction confidence level satisfies the second user device handover prediction reporting criterion. Based on the second analyzed user device handover prediction confidence level being determined to satisfy the second user device handover prediction reporting criterion, the operations may further comprise transmitting, to the at least one serving radio network node, at least one user device handover prediction report indicative of the second user device handover prediction.

The first user device handover prediction reporting criterion may comprise a specified handover prediction reporting time indication indicative of a specified time with respect to which transmitting of the at least one user device handover prediction report is to be performed to be as late as. The second user device handover prediction reporting criterion may comprise at least one handover prediction learning model confidence level criterion. The adjusted first user device handover prediction reporting criterion may correspond to a time that is sooner than the specified time. The adjusted first user device handover prediction reporting criterion may be based on a battery charge level corresponding to a battery associated with the user device.

### BRIEF DESCRIPTION OF THE DRAWINGS

FIG. 1 illustrates wireless communication system environment.

FIG. 2 illustrates an example environment with a radio network node facilitating traffic scheduling based on a likelihood, predicted by a user equipment, that the user equipment will be handed over to being served by another radio network node.

FIG. 3 illustrates example user equipment handover prediction capability information.

FIG. 4 illustrates example user equipment handover prediction configuration information.

FIG. 5 illustrates an example user equipment handover prediction report.

FIG. 6 illustrates example user equipment handover prediction.

FIG. 7 illustrates an example timing diagram of an example embodiment of a radio network node facilitating handover of a user equipment to another radio network node based on a handover prediction report received from the user equipment.

FIG. 8 illustrates an example timing diagram of an example embodiment of a user equipment predicting handover from one radio network node to another radio network node.

FIG. 9 illustrates a flow diagram of an example embodiment method of a user equipment being handed over from a serving radio network node to target radio network node based on a handover probability determined by the user equipment and indicated to the serving radio network node.

FIG. 10 illustrates a block diagram of an example method embodiment.

FIG. 11 illustrates a block diagram of an example radio network node embodiment.

FIG. 12 illustrates a block diagram of an example non-transitory machine-readable medium embodiment.

FIG. 13 illustrates a block diagram of an example method embodiment.

FIG. 14 illustrates a block diagram of an example user equipment embodiment.

FIG. 15 illustrates a block diagram of an example non-transitory machine-readable medium embodiment.

FIG. 16 illustrates an example computer environment.

FIG. 17 illustrates a block diagram of an example wireless user equipment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

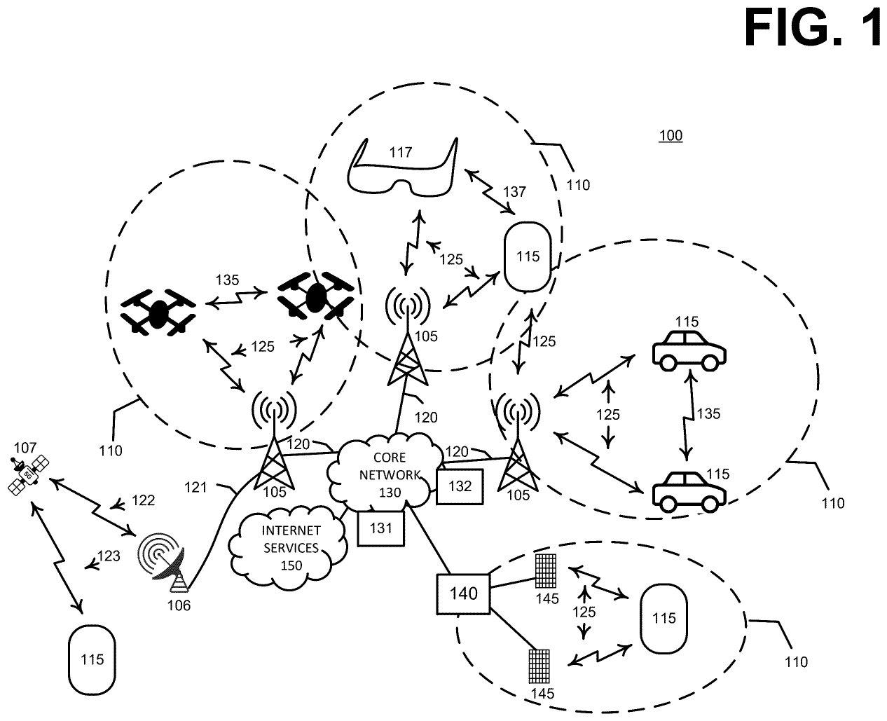

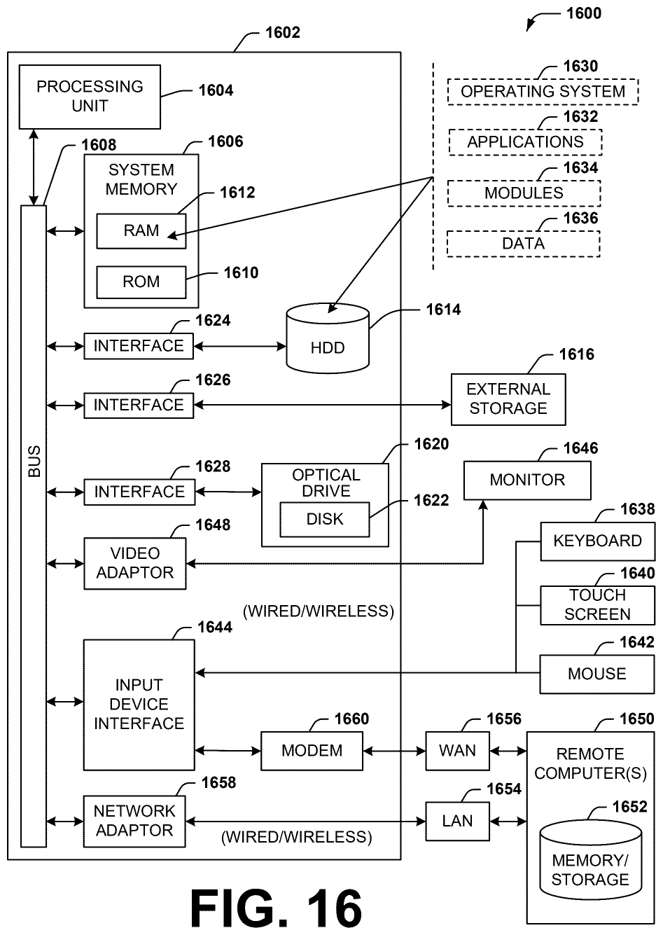

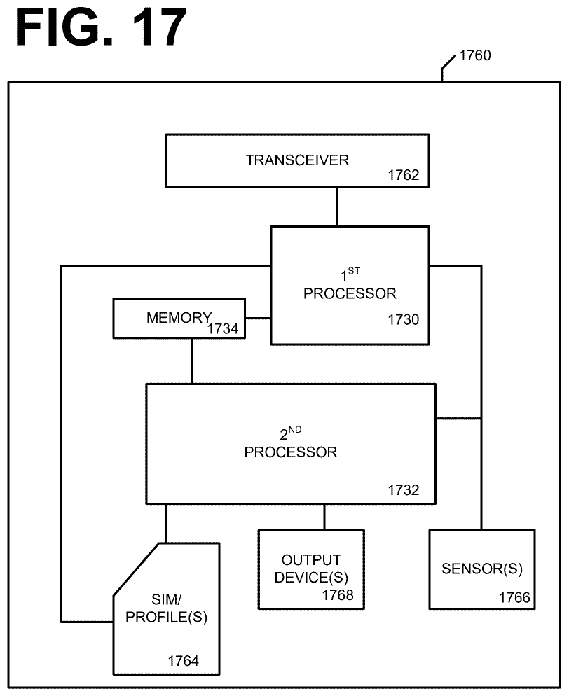

Turning now to the figures, FIG. 1 illustrates an example of a wireless communication system 100. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, may transmit or receive wireless signals with a RAN base station 105 via a long-range wireless link 125, or the UE may receive or transmit wireless signals via a short-range wireless link 137, which may comprise a wireless link with another UE device 115, such as a Bluetooth link, a Wi-Fi link, and the like. A RAN 105, or a component thereof, may be implemented by one or more computer components that may be described in reference to FIG. 16. A UE may comprise components described in reference to FIG. 17.

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling, or control signaling, that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Communication networks such as 5G networks may comprise Next Generation Radio Access Network (“NG-RAN”) equipment and software, and core network equipment to facilitate operation of wireless user equipment (“UE”). An NG-RAN may comprise gNodeBs (“gNBs”) that communicate with the 5G cire network equipment, which may manage overall network functions, including mobility management, session management, and policy control functions.

Handover procedures in 5G can be broadly categorized as corresponding to two handover types. An intra-gNB handover may occur when a UE moves between cells managed by the same gNB and involves relatively simple procedures due to control being facilitated by the same gNB. A second type of 5G handover may comprise Inter-gNB Handover wherein a UE moves between cells managed by different gNBs and may be more complex than intra-gNB handover due to the need for coordination between different gNBs and core network equipment. A handover process typically involves three main phases. During a preparation phase, an initial detection, or determination, that a handover is required is made. According to conventional techniques, a serving, or source, gNB, to which a UE is currently connected, initiates a handover process by identifying one or more target gNBs and preparing the targets for a potential handover. An execution phase of a handover procedure comprises an actual transfer of context information and a data path corresponding to a user equipment from a source gNB to a target gNB and may facilitate the user equipment maintaining a connection without interruption. A completion phase may comprise the user equipment resuming normal operation with the target gNB that the user equipment has been handed over to and the source gNB may also perform cleanup activities to release resources associated with the handover.

Signal flow during a 5G handover may involve several exchanges of messages between a user equipment being handed over, the serving/source gNB, a target gNB, and the core network equipment. The UE continuously, or periodically, measure radio signal quality parameters with respect to node coverage areas, or cells, that are neighbors to, or that are adjacent to, a cell corresponding to a serving cell and may report measured signal parameter values to a serving/source gNB. The user equipment may measure radio signal quality parameters according to at least one radio resource management (“RRM”) technique. Based on measurement reports comprising the measured signal parameter values, the source gNB may determine whether a handover is necessary and may send a handover request to a target gNB this handle is determined to be required. Responsive to the handover request, the target gNB may prepare to receive the user equipment and may send a handover acknowledgment back to the source gNB. The source gNB may coordinate with core network equipment to switch a data path from the source to the target gNB. The source gNB may send to the user equipment a handover command instructing the user equipment to switch to the target gNB. The user equipment synchronizes with the target gNB and establishes a new connection therewith. The target gNB informs core network equipment that the handover has been completed and the core network updates routing information to reflect the new/switched data path. The user equipment sends a handover completed message to the target gNB to finalize the handover process.

RRM measurement is a radio procedure or process that facilitates maintaining stable radio connections between radio network nodes and user equipment. When a user equipment is engaged with a serving radio network node in an active communication session, the user equipment may be configured to periodically switch from conducting the communication session with the serving cell/RAN node to facilitate measuring, by the user equipment, coverage level (e.g., signal strength) corresponding to one or more nearby/neighboring RAN nodes. To facilitate the periodic switching, the serving RAN node configures the user equipment with periodic measurement timing gaps, or occasions, having duration long enough to facilitate the user equipment executing cell/node switching and executing RRM measurement signal strength measurements with respect to neighboring nodes, or reporting the measured signal strength values to the serving RAN node.

Accordingly, when a user equipment switches back to operation with respect to the serving cell/RAN node, the user equipment resumes the active communication session and payload exchange with the serving RAN and reports back the one or more measurement values associated with the nearby/neighboring RAN cells/nodes to the serving RAN node. Such reporting process can be the basis of triggering a handover from the current serving RAN node to any of the nearby nodes if one of the nearby/neighboring nodes may provide a better received coverage level that the current serving RAN node.

RRM measurement may facilitate reliable, prolonged radio connectivity corresponding to a communication session. By periodically checking whether nearby cells/RAN nodes other than a currently-serving RAN node would provide better coverage performance for a user equipment than a currently connected serving RAN node/cell, a user equipment may be able to transition (e.g., be handed over) to being connected with one of the neighboring RAN nodes. Thus, in case of a sudden, unpredicted radio link failure, which may result from, for example, a signal blockage or an interference signal bursts, a user equipment can be immediately handed over to an already-measured cell/node, adjacent to a currently-serving RAN node, that has been determined, based on previous measurement, to offer a coverage level/signal strength, that is acceptable to the user equipment. However, to execute RRM measurement according to conventional techniques, a currently-serving RAN node defines RRM measurement timing gaps/occasions that are considered ‘silent’ periodic periods during which a current communication session between a user equipment and the RAN node is halted, suspended, or paused. Therefore, user equipment can reliably switch from operations with the serving RAN node and execute RRM measurement procedures with respect to one or more available neighboring cells during a configured RRM measurement timing gap/period, during which the currently-serving RAN node does not send, or expect to receive, any payload with respect to the user equipment. Since RRM measurement timing gaps/occasions effectively reduce capacity with respect to a user equipment and with respect to overall network capacity corresponding to a serving RAN node since a RRM measurement gap/occasion is essentially an inactive communication period, it is desirable that configuring and scheduling of RRM measurement be optimized to minimize impact of RRM procedures on communication link capacity or on network capacity.

A user equipment device, or a user device, may move away from a source/serving RAN node towards a target RAN node that corresponds to a coverage level/signal strength perceived, or determined, by the device that is better than, or that exceeds, a perceived signal strength corresponding to the source/serving ran node. Handover procedures according to conventional techniques may be triggered by a serving RAN node to facilitate an active device session resuming on a target RAN node. Thus, according to conventional techniques, handover is a reactive function wherein devices must first experience coverage degradation from the serving cell before the RAN network triggers a potential handover procedure and may result in total radio link failure if coverage/signal strength/quality degrades at the user equipment before the serving RAN node can trigger a handover procedure with respect to the user equipment. Attempts have been made to proactively determine, or predict, at a serving RAN node, handover events using artificial-intelligence-facilitated handover predictions based on device-reported coverage/signal strength/quality measurement values. Although the use of artificial intelligence learning models to facilitate determining, at a serving radio network node, that a user equipment device should be handed over to a target radio network node may improve handover determination as compared to techniques that do not use artificial intelligence at a serving radio network node to determine that a user equipment should be handed over, such determination at a serving radio network node nevertheless is based on measured coverage level signal strength/quality values received from the user equipment and does not solve the problem of using actual real-time diverse radio conditions experienced by the user equipment to determine that the user equipment should be handed over to a target radio network node.

User equipment devices are increasingly equipped with, or configured with, artificial intelligence capabilities. According to novel techniques disclosed herein, artificial intelligence capabilities of a user equipment device may be used to proactively determine, or predict, that a handover event corresponding to the user equipment with respect to a serving radio network node and a target radio network node is likely to occur during a predicted handover period. Accordingly, use of artificial intelligence capabilities of a user equipment to predict a handover event facilitates solving of problems associated with handover events being predicted by a serving radio network node.

According to example embodiments disclosed herein, a user equipment may indicate to a serving radio network mode at least one artificial intelligence capability corresponding to the user equipment may be used to predict that a handover event is likely to occur during a predicted handover period and may indicate to the serving radio network node a prediction of the predicted handover event. According to example embodiments disclosed herein, the serving radio network node may determine, or adjust, scheduling of buffered traffic directed to the user equipment based on a report, received from the user equipment, that is indicative of a predicted handover event determined by the user equipment.

According to example embodiments disclosed herein, a serving radio network node may configure an AI-capable user equipment device with information to facilitate proactive handover event prediction and conditional reporting criteria such that an AI-capable user equipment device may only report to the serving radio network node a predicted handover event if a minimum configured AI model confidence level criterion is satisfied. Thus, the serving radio network node may avoid being misled by in prediction, received from the user equipment, of a predicted handover event that may not have been determined by the user equipment by an artificial intelligence learning model corresponding to a confidence level that equals or exceeds the configured confidence level criteria. After a serving radio network node receives a report indicative of a predicted handover event, the serving radio network node may be aware of a time value corresponding to they predicted handover (e.g., the serving RAN node is made aware of a start time or a duration of a handover prediction period during which a predicted handover event is predicted to occur). Based on receiving, from a user equipment, a prediction of a predicted handover event, the serving radio network node may override a default, or configured, resource scheduling policy by prioritizing scheduling and transmission of latency-critical pending/buffered traffic packets directed to the user equipment having a remaining latency/delay budget that will likely be violated, or not satisfied, and thus the packets may be deemed not useful, if transmitted after the predicted handover event is executed and the user equipment is handed over to a target radio network node. (Handover may take tens of milliseconds to complete and a remaining latency/delay budget corresponding to a packet directed to a user equipment may be less.) Accordingly, embodiments disclosed herein may facilitate a serving radio network node dynamically, and responsive to receiving a handover prediction from a user equipment, adjusting scheduling of packets directed to a user equipment based on one remaining delay budget corresponding to the package and based on a handover prediction time corresponding to a handover event indicated by a handover prediction report received from the user equipment.

A serving radio network mode may desire, or prefer, that an AI-capable user equipment be configured with a preferred handover prediction period during which the user equipment may predict that a handover event may occur and wherein the preferred handover prediction period may be a time relative to reporting, by the user equipment to the serving radio network node, a report indicative of a handover event prediction. For example, the serving radio network node may prefer a longer time between a handover event prediction report being reported to the serving radio network node and a handover event prediction period indicated by the handover event prediction report because the longer the time between the reporting of a handover event prediction and the period during which the handover event is predicted to occur the better, or more efficiently, the radio network node can schedule resources allocated to transmission of buffered packets to the user equipment compared to a time between reporting of a handover event prediction and the start of al handover prediction period indicated by a handover prediction report being shorter. However, a user equipment device may not always be able to generate a handover event prediction using a learning model having a certain prediction reliability/accuracy. A longer-duration, sooner-occurring handover prediction period may be more desirable at a user equipment due to real-time device-specific conditions (e.g., an already-low battery charge level that may be depleted by high-complexity calculations performed by a learning model that must predict a handover during a short prediction period and far into the future). Thus, a user equipment may relax an AI learning model capability temporarily and indicate to a serving radio node that user equipment is currently not capable of using an AI learning model to predict a handover event likelihood or the user equipment may adjust a preferred handover time criterion indicated by the serving radio network node to the user equipment via handover prediction configuration information. Accordingly, an AI-capable user equipment device may adaptively and locally determine, and report back to a RAN node currently serving the user equipment, varying AI-predicted handover periods using a learning model corresponding to a minimum needed AI model accuracy, configured by the serving RAN node, based on real-time device conditions.

According to conventional techniques, packet scheduling procedures at a radio network node are handover-unaware such that scheduling of buffered packets is independent of a handover state of a user equipment device corresponding to whether the user equipment device is about to be, or is not about to be, handed over to a target RAN node. Thus, a serving RAN node may be ‘surprised’ if a user equipment device is handed over to another RAN node while having latency-critical buffered packets directed to the user equipment device having latency targets that may be violated due to delay in the user equipment being handed over from the serving RAN node to a target RAN node. According to example embodiments disclosed herein, packet scheduling may be handover-aware such that latency-critical buffered packets are instantly prioritized, by overriding default scheduling priority/policy at the serving RAN node, for transmission before a predicted handover, predicted by the user equipment device, is executed, thus facilitating avoiding violating delay criterion corresponding to the packets.

According to conventional techniques, handover is either fully reactive at a serving RAN node based solely on radio parameter measurement reports received from devices or handover is proactive and AI-model-driven at a serving RAN node but still based solely on reaction to radio parameter coverage reports received from user equipment (e.g., a coverage problem needs to occur before the serving RAN node triggers, or predicts triggering of, a handover. According to novel example embodiments disclosed herein, handover prediction may be locally executed at a user equipment device instead. According to example embodiments disclosed herein, a user equipment device may independently determine a handover prediction period based on a real-time capability or radio conditions corresponding to the user equipment such that a handover event prediction satisfies a minimum needed prediction confidence criterion, configured by a serving radio network node, and such that the user equipment can modify a preferred prediction time criterion, configured by the serving radio network node, to avoid overwhelming the user equipment with high complexity processing corresponding to a high complexity learning model if, for example, a battery charge level corresponding to the user equipment is equal to or below a configured battery charge level criterion.

### Handover-Aware Proactive Traffic Scheduling.

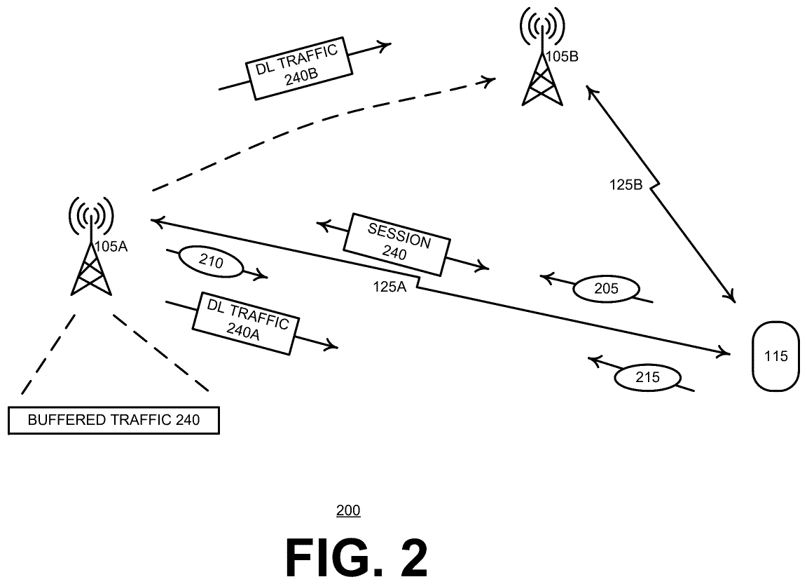

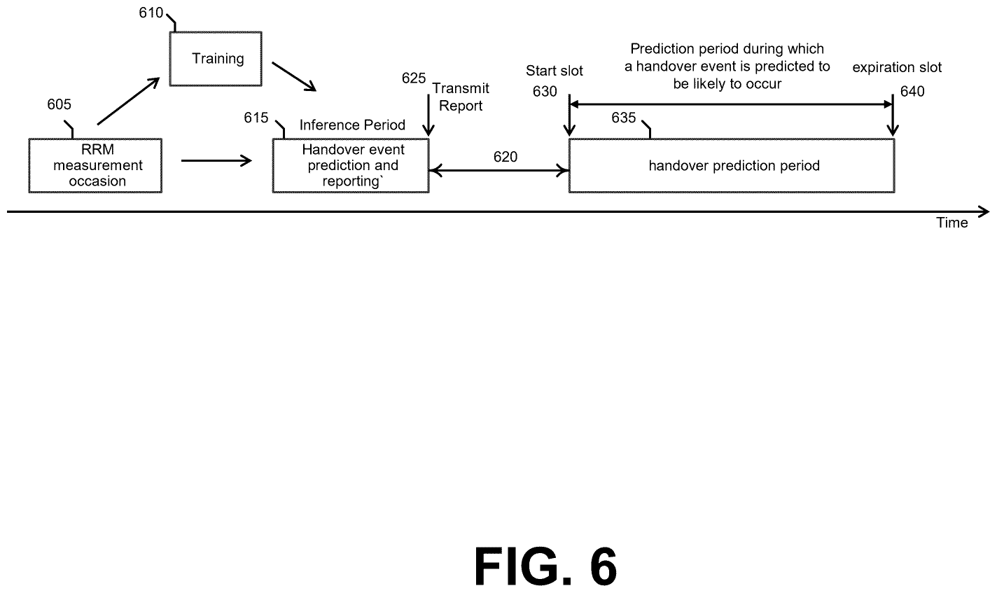

Turning now to FIG. 2, environment 200 may comprise a radio network node 105A and user equipment 115. User equipment 115 may represent more than one user equipment. One user equipment is illustrated for purposes of clarity and simplicity. User equipment 115 may be configured by serving RAN node 105A to perform radio resource management (“RRM”) measurements during at least one resource management measurement occasion, or gap (e.g., shown as occasion 605 in FIG. 6). One or more radio resource management measurement occasions may be configured such that user equipment 115 may temporarily suspend, or pause, communication of traffic, corresponding to a communication session being conducted with respect to serving RAN node 115A, which may be facilitating the communication session.

Serving RAN node 105A may receive, via the uplink radio interface link(s) 125 from UE 115, user equipment capability information 205, shown in FIG. 2. Capability information 205 may comprise a binary indication of a capability corresponding to UE 115 to predict, using an artificial intelligence (“AI”) learning model, prediction of likely handover events, for example, an indication of a handover event A1, A2, A3, A4, A5, B1, or B2. Such dynamic uplink signaling allows serving RAN node 105 to be made aware of a real-time AI capability of UE 115 to predict certain handover events. Such capability indicated by capability information 205 can be varying in real time for various reason, such as, for example, when a battery charge corresponding to a better associated with the user equipment 115 is low, the user equipment may determine to avoid predicting handover events, and thus may indicate to RAN node 105A, via information 205, the determined capability reduction such that the RAN node does not expect to receive from the user equipment the handover prediction to facilitate scheduling transmission to the user equipment of packets associated with session 240.

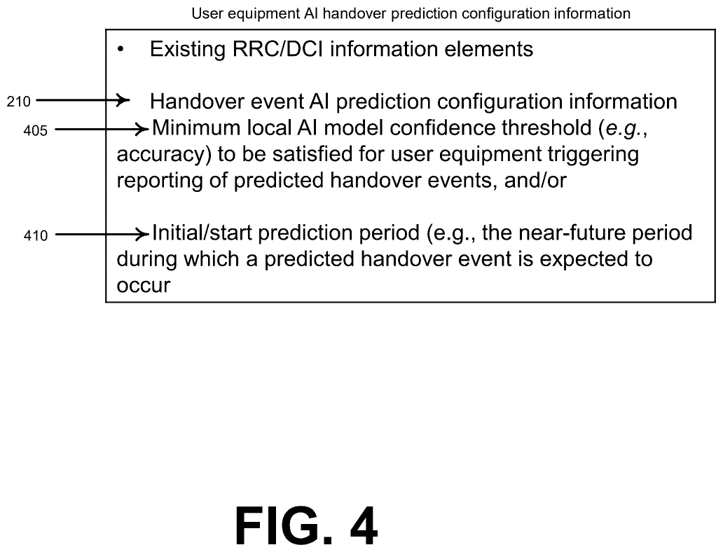

RAN node 105A may transmit, via downlink radio interface link(s) 125 toward UE 115, user equipment handover event prediction configuration information 210 that may be usable by the user equipment to facilitate applying an AI learning model to radio condition information measured by the user equipment to determine a prediction of a likelihood that the user equipment may need to be handed over to another RAN node, for example RAN node 105B shown in FIG. 2, which may be referred to as a target RAN node. As shown in FIG. 4, configuration information 210 may comprise at least one of: at least one minimum local AI model confidence threshold criterion (e.g., accuracy criterion), shown in field 405, to be satisfied to trigger reporting, by UE 115, of at least one handover event prediction; or at least one preferred predicted handover time value in field 410, for example a preferred initial/start or duration of a prediction period (e.g., a start time or a duration period in the near-future during which the serving RAN ‘preferes’ that UE 115 predict that a handover event indicated in field 405 is expected, or predicted, by the user equipment, to occur). For example, a time value indicated in field 410 may be indicative that user equipment 115 is preferred to predict that a handover event is likely to occur, or that handover is likely to be needed, during five time slots beginning with an indicated beginning slot that is indicated as starting at a particular time. A confidence criterion, indicated in field 405, may facilitate a minimum confidence level, corresponding to an AI learning model being executed by the user equipment to predict a handover, being achieved before the user equipment reports handover prediction information, indicative of the predicted handover, back to serving RAN node 105A such that the serving RAN node is not ‘misled’ by a low-accuracy handover prediction made by the user equipment.

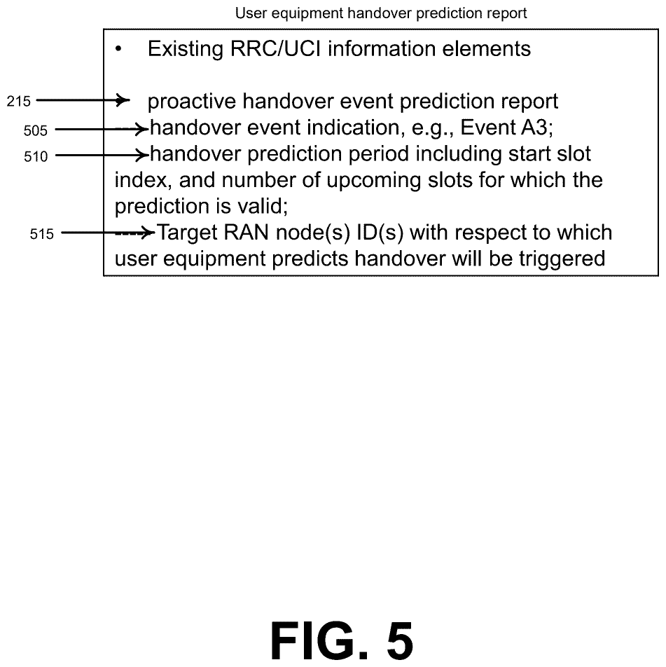

RAN node 105A may receive, from user equipment 115, proactive handover event prediction report 215, which may be referred to as a user equipment handover prediction report, that may be indicative of at least one user equipment handover prediction determined by the user equipment, via an uplink control channel. Report 215 may comprise at least one of: at least one handover event indication shown by field 505 in FIG. 5. In field 510, report information 215 may comprise at least one predicted handover time indication indicative of at least one predicted handover time. A predicted handover time may comprise a start slot index indication indicative of a start of a prediction period and a number of slots, following the start, with respect to which a handover event prediction indicated in field 505 is to be valid or likely. An indicated prediction time may comprise a prediction expiration time. An indicated prediction time may comprise a length of time corresponding to a prediction period during which a prediction indicated by field 505 may be valid (e.g., a period during which the UE 115 expects, or predicts, that a handover event indicated in field 505 may be actually experienced with at least a minimum AI model prediction confidence/accuracy configured via field 405 shown in FIG. 4). A prediction period time indicated by field 510 may be different than a preferred prediction period time indicated in field 410 of configuration information 210. Report 215 may comprise at least one target RAN node identifier corresponding to at least one potential target RAN node (e.g., RAN node 105B shown in FIG. 2) to which user equipment 115 predicts handover, indicated by field 505, may be requested during a period indicated by field 510.

Based on receiving a proactive handover event prediction report 215, serving RAN node 105A may calculate, or otherwise determine, at least one remaining delay budget corresponding to at least one protocol data unit (e.g., at least one packet) of traffic corresponding to session 240, buffered by RAN node 105A, pending transmission to user equipment 115. Determining at least one remaining delay budget corresponding to at least one buffered packet corresponding to session 240 may facilitate serving RAN node, based on information corresponding to likely device handover in near future to another RAN node as indicated by report 215, determining which of one or more packets to schedule and transmit to user equipment 115 before an expected handover indicated by report 215 is experienced to minimize likelihood that the target delay budget(s) corresponding to the buffered packet(s) is/are violated.

Based on serving RAN node 105A determining one or more buffered packets 240A corresponding to session 240 having remaining delay budgets that expire within a reported handover prediction period indicated by field 510, RAN node 105A may prioritize scheduling and transmitting of the determined latency-critical packets during a period preceding a start of a reported handover prediction period indicated by field 510. For example, if serving RAN node 105A determines that a buffered packet 240A has a remaining delay budget that expires during handover prediction period 635 shown in FIG. 6, the serving RAN node may schedule the buffered packet for transmission during period 620, which precedes start time 630 corresponding to predicted handover period 635 that may be indicated by field 510. Thus, latency-critical buffered packets, which cannot tolerate being buffered until handover to target RAN node 105B has been completed, which completion may not occur until end 640 of period 635, may be prioritized for scheduled transmission before the expected handover is actually experienced (e.g., before start time 630). If serving RAN node 105A determines that one or more buffered packets 240B have remaining delay budgets that are set to expire after a reported handover prediction period indicated by field 510, RAN node 105A may trigger handover request procedures, via backhaul/XN interface link(s) 120, to facilitate handing over of UE 115 to being served by target RAN node 105B and RAN node 105A may transmit to target RAN node 105B packet(s) 240B for transmission thereby to UE 115 after UE 115 has established a connection with RAN node 105B based on the handover procedures initiated by RAN node 105A.

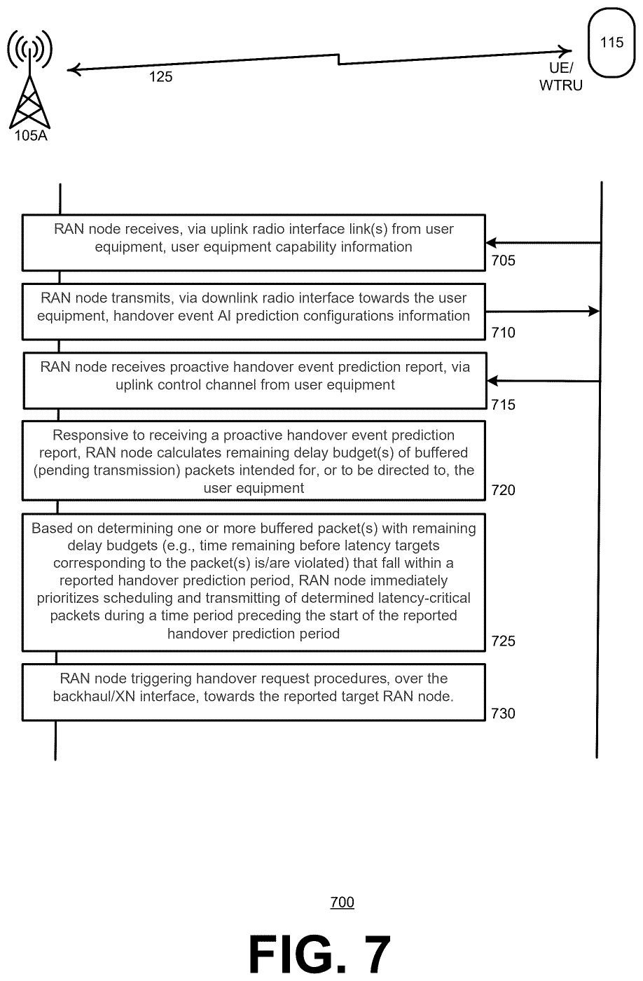

Turning now to FIG. 7, the figure illustrates a timing diagram of an example embodiment method 700 to facilitate radio network node 105A scheduling delivering of traffic corresponding to a communication session associated with UE 115. At act 705, serving RAN node 105A may receive, via uplink radio interface link(s) 125 from UE 115, user equipment capability information. User equipment capability information received at act 705 may comprise a binary indication of a device capability associated with UE 115 for AI-powered prediction of handover events. At act 710, RAN node 105A may transmit, via downlink radio interface link(s) 125 toward UE 115, handover event AI prediction configuration information, for example information 210, that may comprise a minimum local AI model confidence threshold (e.g., a criterion indicated in field 405) to be satisfied to trigger reporting of at least one predicted handover event. Prediction configuration information transmitted at act 710 may comprise at least one time indication (e.g., indicated by field 410) indicative of at least one preferred prediction period, or at least one initial/start time corresponding thereto, during which a predicted handover event is expected to occur (e.g., UE 115 may predict that a certain handover event is likely to be experienced during five upcoming slots starting from an indicated start slot or start time). At act 715, RAN node 105A may receive a proactive handover event prediction report, such as report 215, via uplink control channel resources from UE 115. Report 215 received at act 715 from UE 115 may comprise a handover event indication, a handover prediction period, or a predicted handover period, including a start slot index, and a number of upcoming slots during which a predicted handover event is likely to occur (e.g., a near-future period during which UE 115 predicts/expects, with at least a minimum AI model prediction confidence/accuracy configured via information received at act 710, an indicated handover event to be actually experienced), or at least one target RAN node identifier indicative of at least one target RAN node towards which UE 115 predicts a handover indicated by report 215 is likely to be triggered during the predicted handover period. At act 720, based on receiving a proactive handover event prediction report 215 at act 715, RAN node 105A may calculate at least one remaining delay budget corresponding to at least one buffered packet pending transmission to UE 115. On condition of determining one or more buffered packets with remaining delay budgets that expire before an end, or expiration, of a handover prediction period indicated by report 215, at act 725 RAN node 105A may immediately prioritize scheduling and transmitting of the latency-critical packets, determined at act 720, during, or at, a time preceding a start of a handover prediction period indicated by report 215. At act 730, RAN node 105A may trigger handover request procedures, via backhaul/XN interface link(s), toward a target RAN node identified in report 215 received at act 715.

### Time-Bound Dynamic Device Handover Event Reporting.

Returning to description of FIG. 2, UE/WTRU 115 may transmit, towards serving RAN node 105A, device capability information 205, which may comprise a binary indication indicative of a capability corresponding to the user equipment to determine, or predict, at least one handover event using at least one AI learning model. Capability information 215 may facilitate making serving RAN node 105A aware of a real-time user equipment capability of user equipment 115 to predict one or more handover events. Such handover event prediction capability may vary based on various factors, including a battery charge level corresponding to user equipment 115 being determined to be low, that may result in UE 115 determining to avoid, or to not resume, predicting handover events, at least while the battery charge level is low. Accordingly, UE 115 may indicate to serving RAN node 105A that handover event prediction has been reduced or curtailed to facilitate the serving RAN node avoiding reliance on receiving, from UE 115, a handover event prediction on which to base determining of scheduling transmission of a packet, directed to UE 115, that may be buffered at the serving RAN node.

As shown by FIG. 2, UE/WTRU 115 may receive, from RAN node 105A via downlink radio interface link(s) 125, user equipment handover event prediction configuration information 210. Information 210 may be received in response to transmitting capability information 205, or information 210 may be transmitted to UE 115 even if the UE has not transmitted to RAN node 105A information 205. UE/WTRU 115 may perform, execute, or cause an AI learning model to be trained during training period 610 based on RRM radio parameters measured with respect to serving RAN node 105A or measured with respect to one or more potential target RAN nodes to which the user equipment may be potentially handed over to if the user equipment determines a prediction event. UE/WTRU 115 may perform, execute, or cause to be executed AI model inference operations (e.g., prediction of at least one handover events that UE 115 may have been configured to determine at least one handover prediction) during inference period 615 based on executed inter-cell (and/or inter-frequency) RRM parameter measurements. UE 115 may perform a handover prediction inference operation using a configured preferred initial/start prediction period, which may be indicated in field 410 of information 210 shown in FIG. 4, as an initial handover period prediction. The initial, or preferred, handover prediction period may be revised by UE 115 based on a real-time AI capability corresponding to the user equipment (e.g., the aforementioned battery charge level) and a minimum confidence level, corresponding to the AI learning model, to be satisfied (e.g., a confidence level configured via field 405 in information 210) to be usable by UE 115 to trigger proactive handover prediction reporting. Real-time AI capability may be time variant insofar as an AI capability may not depend solely on hardware corresponding to UE 115 that may be available to facilitate AI learning model operation, but may also be based on a real-time state of UE 115, such as, for example, a current battery level if a battery charge level corresponding to UE 115 is equal to or below a configured prediction reporting battery criterion, UE 115 may relax part of, or all, AI capabilities to reduce energy consumption by the UE until the battery charge level equals or exceeds the battery criterion.

To facilitate relaxing of determining, by an AI learning model, prediction of a likelihood of a handover being needed, based on determining am accuracy/confidence level corresponding to the AI learning model being equal to or less than a minimum threshold configured the field 405, or based on a reduced device capability, which may occur due to device high temperature or device low battery level corresponding to user equipment 115, the user equipment may decrease (e.g., set earlier) a start time of a preferred prediction period indicated by field 410 according to a predefined and/or device-specific timing offset, and may re-execute the AI model inference (e.g., re-execute prediction of at least one configured handover event) using the updated sooner target prediction period as an updated prediction period. Thus, UE 115 may dynamically make a handover prediction period sooner than a prediction period start time preferred by RAN node 105A and indicated by field 410, to facilitate predicting a likelihood of occurrence of at least one handover event according to a configured minimum needed AI accuracy/model confidence level configured the field 405.

In reference to FIG. 6, increasing a length of period 635, or shortening/reducing the time length of period 620, may reduce AI model complexity and concomitant processor usage, and thus battery charge consumption, because handover prediction period 635 occurring sooner with respect to transmitting of a user equipment handover prediction report at 625 or start time 630 occurring sooner with respect to transmitting of a user equipment handover prediction report at 625 may result in reduced processor resources used or battery charge consumed by operating an AI learning model that generates a handover event being predicted to occur during period 635 according to a confidence level that satisfies a criterion configured via field 405. In other words, computations performed by an AI learning model with a given confidence level to result in prediction of a handover event occurring during period 635 may be less complex, and thus may require less energy, if period 635, or start 630 corresponding to period 635, occurs sooner with respect to transmitting of a user equipment handover prediction report at 625 than if a handover prediction period 635 occurs later with respect to transmitting of a user equipment handover prediction report at 625.

Based on determining an accuracy/confidence level corresponding to an AI learning model, that may be executed during inference operations during period 615, that is equal to or greater than a configured minimum threshold (e.g., configured via field 405 shown in FIG. 4), UE/WTRU 115 may trigger transmitting of a proactive user equipment handover prediction report 215 to serving RAN 105A at 625. Report 215 may comprise at least one handover event indication in field 505. Report 215 may comprise in field 510 at least one handover prediction period time value indication indicative of a predicted handover period, (e.g., indicative of a start time of, or a duration of, period 635 shown in FIG. 6). A handover prediction time value indicated in field 510 may comprise at least one start slot index indicative of a start time of a predicted handover period (e.g., indicative of time 625 shown in FIG. 6). Report 215 may comprise at least one value indicative of a number of one or more upcoming slots during which a predicted handover event indicated in field 505 is valid with respect to an indicated start time/slot. For example, information indicated in field 510 may be indicative of a near-future period 635 during which UE 115 expects, with at least the minimum configured AI model prediction confidence/accuracy indicated in field 405, a handover event indicated in field 505 to be likely to be experienced by the UE. Report 215 may comprise at least one target RAN node identifier indicative of at least one target RAN node to which UE 115 predicts handover may be triggered during a period indicated by field 510.

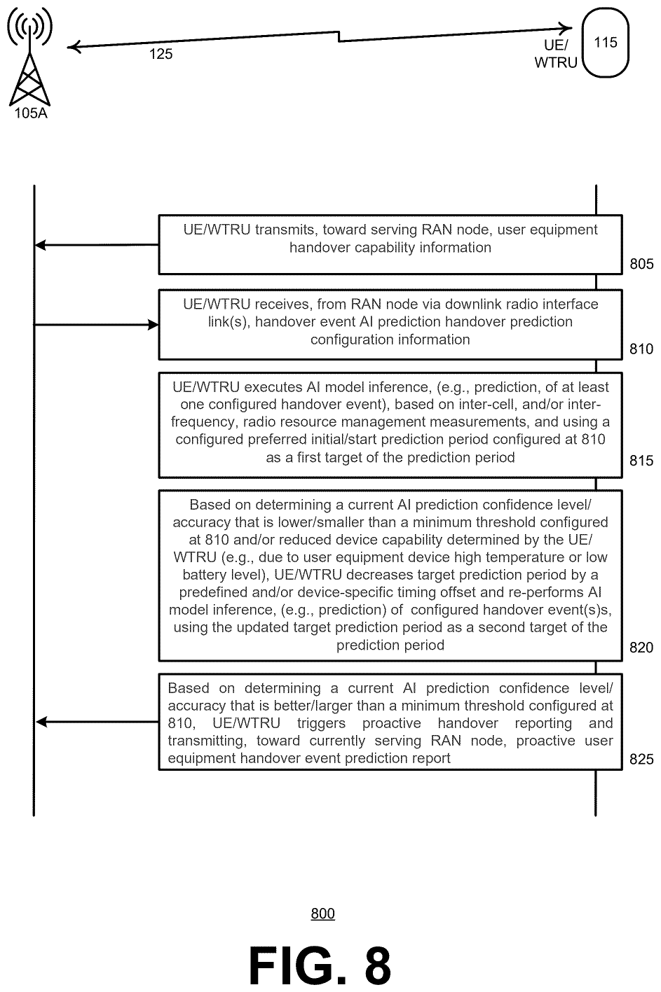

Turning now to FIG. 8, the figure illustrates a timing diagram of an example embodiment method 800 to facilitate user equipment 115 predicting that radio conditions will warrant UE 115 being handed over from serving radio network node 105A to a target radio network node. At act 805, user equipment 115 may transmit, to serving RAN node 105A via radio interface link(s) 125, user equipment handover prediction capability information. Capability information transmitted at act 805 may comprise an indication of a capability of UE 115 to operate an artificial intelligence learning model to predict at least one handover event. At act 810, UE/WTRU 115 may receive, from RAN node 105A via downlink radio interface link(s) 125, handover event AI prediction configuration information (e.g., information 210) that may comprise a local AI model accuracy/confidence level threshold/criterion to be satisfied for UE 115 to trigger reporting of predicted handover events to RAN 105A. User equipment handover prediction configuration information received at act 810 may comprise at least one initial/start prediction period indication indicative of at least one preferred near-future period during which a handover event expected to occur and with respect to which UE 115 preferably should indicate the predicted at least one handover event to RAN 105A. At act 815, UE/WTRU 115 may execute AI model inference/prediction with respect to at least one handover event based on inter-cell and/or inter-frequency RRM parameter measurements determined by UE 115 and processed by an AI learning mode being executed by UE 115. Inference/prediction performed at act 815 may comprise using a preferred prediction period, configured at 810, for example via field 410 of configuration information 210, as a first/initial prediction period. At act 820, on condition of determining a current AI model prediction confidence level/accuracy that is equal to or less than a minimum threshold configured at act 810, or based on a reduced device capability (e.g., due to device high temperature or low battery level), UE/WTRU 115 may increase a target prediction period duration or may make sooner a start of a prediction period, for example by shortening a predefined or device-specific timing offset (e.g., shortening period 620 shown in FIG. 6) and re-execute AI model inference/prediction with respect to the at least one configured handover event using the updated prediction period, or updated start time thereof, as an updated prediction period. On condition of determining a current AI prediction accuracy/confidence level that equals or exceeds a minimum threshold/criterion configured via field 405 of information 210, at act 825 UE/WTRU 115 may trigger proactive handover reporting and transmitting, towards currently-serving RAN node 105A, a proactive handover event prediction report 215 for use thereby to determine/update scheduling of pending/buffered traffic packets directed to UE/WTRU 115 or to determine a target RAN node to which UE/WTRU 115 is to be handed over.

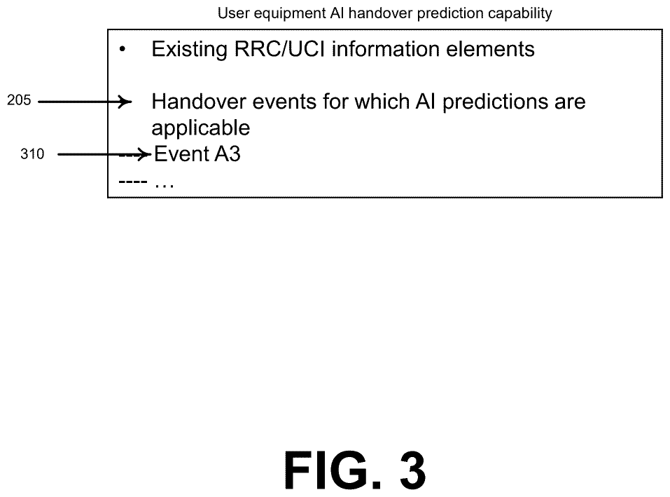

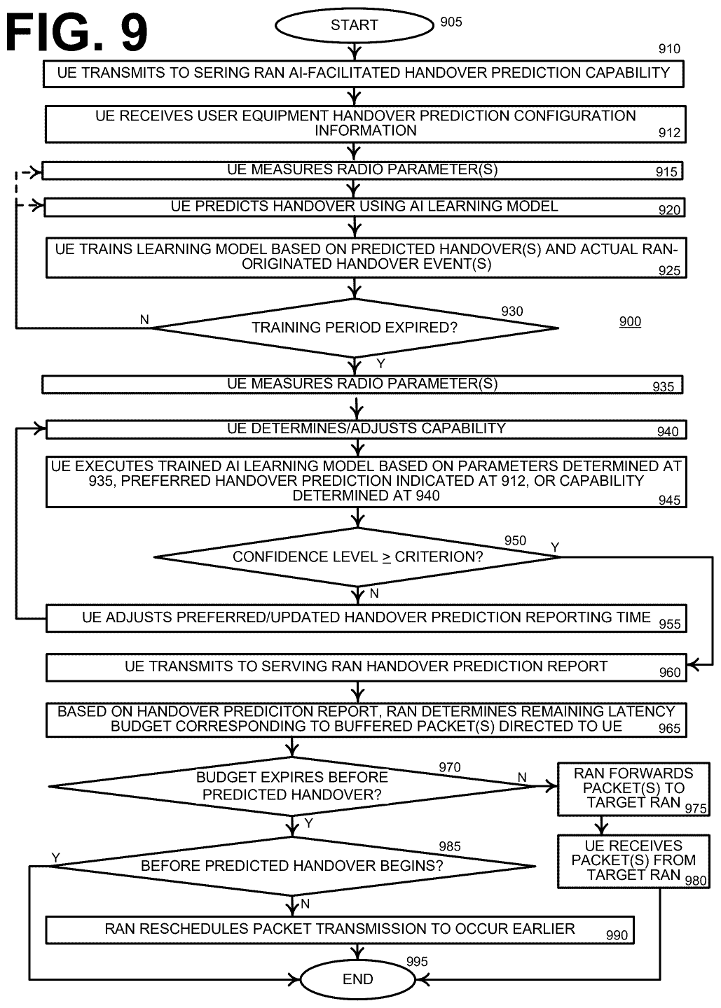

Turning now to FIG. 9, the figure illustrates a flow diagram of an example embodiment 900. Method 900 begins at act 905. At act 910, a radio network node, or a network element comprising, or corresponding to, a radio network node, may receive from a user equipment, user equipment handover prediction capability information (e.g., capability information 205 described in reference to FIGS. 2 and 3). At act 912, the user equipment may receive user equipment handover prediction configuration information (e.g., configuration information 210 described and reference to FIGS. 2 and 4) from a radio access network node that is currently serving the user equipment. At act 915, the user equipment may perform radio resource management measurement operations and may determine radio parameter measurement values. The radio parameter measurement values may be determined with respect to the serving radio network node or a neighboring network node to which the user equipment may potentially be handed over. At act 920, using an artificial intelligence learning model, based on configuration information received at act 912, the user equipment may predict a likelihood of a handover event occurring during a handover prediction period, for example period 635 shown in FIG. 6. At act 925, the user equipment may train the artificial intelligence learning model based on at least one predicted handover determined or predicted at act 920 and also based on actual handover events determined by, or originated by, the serving radio network node. At act 930, the user equipment may determine whether a training period, for example period 610 shown in FIG. 6, has expired. If a determination is made at act 930 that a training period has not expired, method 900 may return to act 915 or act 920. (The return paths from act 930 to acts 915 and act 920 are shown with broken lines to indicate that either or both paths may be followed if a determination is made at act 930 that it training period has not expired.)

If a determination is made at act 930 that a training period has expired, at act 935, the user equipment may again measure radio parameters with respect to the serving radio network node or a neighboring radio network node. At act 940, the user equipment may determine or adjust a capability based on at least one user equipment characteristic, parameter, or other factor corresponding to the user equipment. For example, the user equipment may determine that a battery charge level corresponding to a battery associated with the user equipment is below a configured artificial intelligence learning model prediction battery criterion. A low energy charge stored by a battery associated with the user equipment may cause the user equipment to determine not to implement, execute, or otherwise use an artificial intelligence learning model to predict a handover event using configuration information received at 912. For example, configuration information received at act 912 may comprise a confidence level criterion and a preferred handover prediction time/period indication. The handover prediction time indication may be indicative of a preferred start of a handover prediction period relative to a transmitting, to the serving radio network node, of a handover prediction report indicative of a predicted handover event. The handover prediction time indication may be indicative of a preferred duration of a handover prediction period. The longer a delay between transmitting a handover prediction report and a predicted occurrence of a predicted handover as indicated in the handover prediction report the more complex the calculations typically needed to determine, and consequently the more energy that may be consumed in determining, handover prediction. Similarly, the shorter a duration of a handover prediction period, the more accuracy is needed in determining a prediction. A shorter duration of a handover prediction period during which a handover that is predicted to occur may also increase computational complexity because predicting that a handover event will occur during a first size time window is more difficult than predicting that a handover event will occur during a larger second time window. Thus, to achieve a confidence level, corresponding to a learning model that is used to determine the handover prediction, that equals or exceeds a configured confidence level criterion, for example a criterion shown in field 405 of information 210 received at act 912, a high amount of processing by a processor corresponding to the user equipment may be required and thus may result in more energy being consumed by the user equipment in performing a handover prediction. Accordingly, by shortening a duration between a reporting of a handover prediction and a period during which a handover event is predicted to occur, or by increasing a size of a handover prediction period/window (e.g., period 635 shown in FIG. 6), a confidence level configured at 912 may be satisfied by a learning model having less computational complexity than if a duration between reporting of a predicted handover event and a period during which the handover event is predicted to occur is longer or if the prediction period is shorter (e.g., period 635 being longer in duration or start time 630 occurring earlier than a preferred handover prediction period duration or a start time corresponding to a preferred prediction period, respectively, indicated at act 912 may reduce processor loading and battery consumption at the user equipment).

Based on a capability determined, or adjusted, at act 940, at act 945 the user equipment may execute a trained artificial intelligence learning model based on parameter values determined at act 935, based on a preferred handover prediction time indicated by configuration information received at act 912, but based on a capability determined at act 940. At act 950, the user equipment may determine whether a confidence level corresponding to the execution of the trained learning model at act 945 equals or exceeds an accuracy criterion, or a confidence level criterion, which, for example may be configured at act 912 by information indicated by field 405 in configuration information 210. If a determination is made at act 950 that a confidence level corresponding to execution of the learning model at act 945 does not equal exceed a criterion configured via information received at act 912, method 900 returns to act 940. At act 940, the user equipment may adjust, or readjust, a capability, which may result in a period 620 being shortened or a handover prediction period 635 being lengthened, before the user equipment executes the trained learning model according to updated, or adjusted, prediction period time values that may be adjusted based on adjusted capability information. Even if capability information is not adjusted at act 940, failing to satisfy an accuracy or confidence level criterion at act 950 may cause the user equipment to adjust a period 620 or a period 635 to ease, or relax, computational complexity of the learning model such that re-execution of the learning model at act 945 may result in a confidence level corresponding to the learning model that equals or exceeds an accuracy or confidence level criterion configured at act 912.

If a determination is made at act 950 that a confidence level corresponding to execution of a learning model at act 945 satisfies be confidence level criterion configurated act 912, method 900 advances to act 960. At act 960, the user equipment may transmit to the serving radio network node a handover prediction report indicative of a predicted handover event predicted by execution of a learning model at act 945. At act 965, based on receiving the handover prediction report transmitted by the user equipment at act 960, the serving radio network node may determine at least one remaining latency budget corresponding to at least one buffered packet that may be buffered at a buffer corresponding to the serving radio network node and that is, or has been, directed to the user equipment. At act 970, the serving radio network node may determine whether a remaining delay budget corresponding to at least one buffered packet is set to expire (e.g., transmission of the packet may no longer be useful and thus may be invalid) before a predicted handover event period indicated by a report transmitted by the user equipment at act 960. If a determination is made at act 970 that a remaining delayed budget corresponding to at least one packet is not set to expire before a handover prediction period indicated by a report transmitted at act 960 (e.g., the packet may still be useful after a predicted handover event occurs), the serving radio network node may forward, at act 975, the at least one buffered packet to a target radio network node that has been indicated by the user equipment via a report transmitted at act 960 and at act 980 the user requirement may receive the at least one packet from the target radio network node after the user equipment has been handed over to the target radio network node. Method 900 advances to act 995 and ends.

Returning to description of act 970, if the serving radio network node determines that a remaining delayed budget corresponding to at least one buffer packet is set to expire before a predicted handover event occurs, or has been completed, method 900 may advance to act 985. At act 985, the serving radio network node may determine whether the determined remaining delay budget corresponding to the at least one buffered packet may be set to expire before a predicted handover period (e.g., indicated in field 510 shown in FIG. 5) indicated by a predicted handover report transmitted at act 960 is to begin. If a determination is made at act 985 that a remaining delay budget corresponding to the at least one buffered packet is set to expire before a predicted handover period is predicted, via field 510, to start, the serving radio network node may leave unchanged a current scheduling of transmitting of the at least one buffered packet and made transmit the at least one buffer packet according to the current scheduling and method 900 advances to act 995 and ends. If a determination is made at act 985 that a remaining delayed budget corresponding to the at least one buffered packet is not set to expire before a predicted handover period is predicted to start, the serving radio network node may, at act 990, reschedule transmitting of the at least one buffered packet so that transmission of the at least one buffered packet occurs earlier than a current scheduling corresponding to the at least one buffered packet. Thus, the serving radio network node may be able to transmit the at least one buffered packet to the user equipment before a predicted handover event is predicted to be likely to occur according to handover prediction report transmitted by the user equipment at act 960. Method 900 advances from act 990 to 995 and ends.

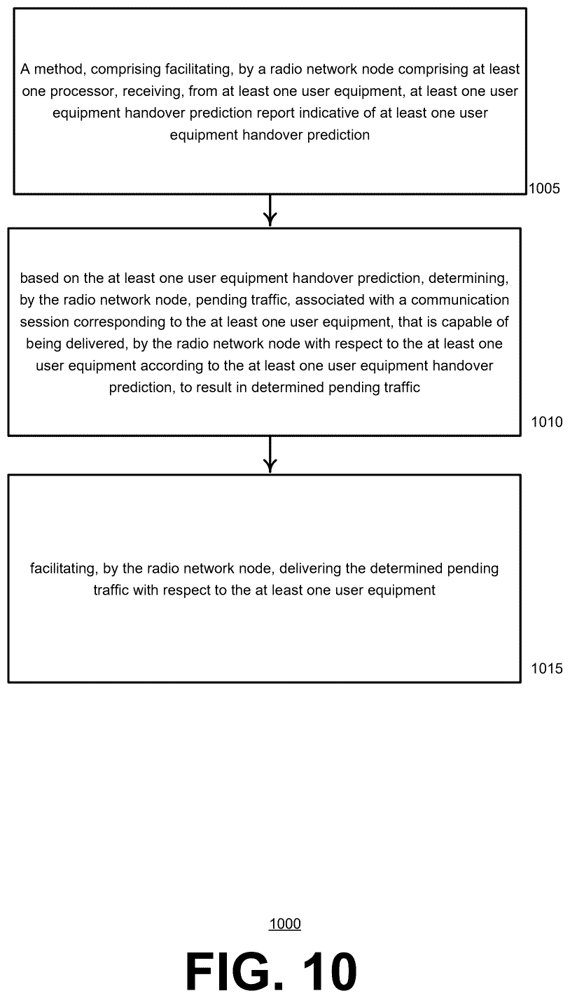

Turning now to FIG. 10, the figure illustrates an example embodiment method 1000 comprising at block 1005 facilitating, by a radio network node comprising at least one processor, receiving, from at least one user equipment, at least one user equipment handover prediction report indicative of at least one user equipment handover prediction; at block 1010, based on the at least one user equipment handover prediction, determining, by the radio network node, pending traffic, associated with a communication session corresponding to the at least one user equipment, that is capable of being delivered, by the radio network node with respect to the at least one user equipment according to the at least one user equipment handover prediction, to result in determined pending traffic; and at block 1015 facilitating, by the radio network node, delivering the determined pending traffic with respect to the at least one user equipment.

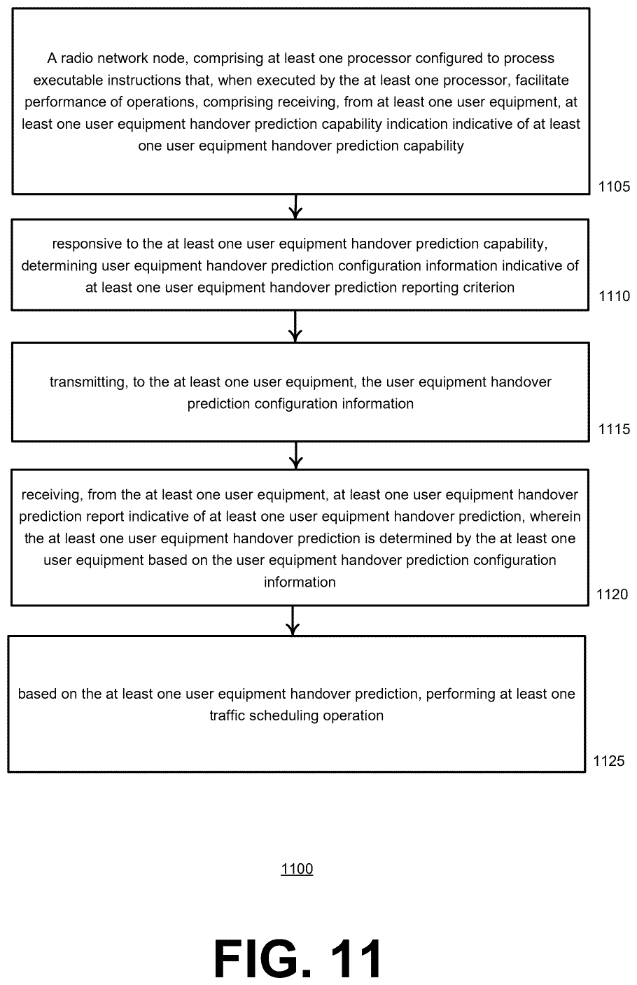

Turning now to FIG. 11, the figure illustrates a radio network node 1100, comprising at block 1105 at least one processor configured to process executable instructions that, when executed by the at least one processor, facilitate performance of operations, comprising receiving, from at least one user equipment, at least one user equipment handover prediction capability indication indicative of at least one user equipment handover prediction capability; at block 1110 responsive to the at least one user equipment handover prediction capability, determining user equipment handover prediction configuration information indicative of at least one user equipment handover prediction reporting criterion; at block 1115 transmitting, to the at least one user equipment, the user equipment handover prediction configuration information; at block 1120 receiving, from the at least one user equipment, at least one user equipment handover prediction report indicative of at least one user equipment handover prediction, wherein the at least one user equipment handover prediction is determined by the at least one user equipment based on the user equipment handover prediction configuration information; and at block 1125 based on the at least one user equipment handover prediction, performing at least one traffic scheduling operation.

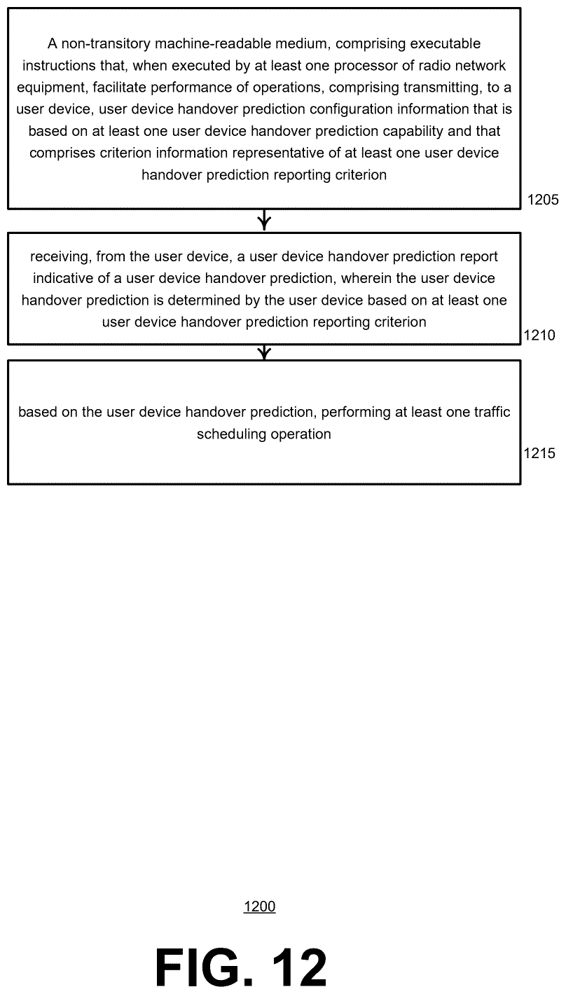

Turning now to FIG. 12, the figure illustrates a non-transitory machine-readable medium 1200 comprising at block 1205 executable instructions that, when executed by at least one processor of radio network equipment, facilitate performance of operations, comprising transmitting, to a user device, user device handover prediction configuration information that is based on at least one user device handover prediction capability and that comprises criterion information representative of at least one user device handover prediction reporting criterion; at block 1210 receiving, from the user device, a user device handover prediction report indicative of a user device handover prediction, wherein the user device handover prediction is determined by the user device based on at least one user device handover prediction reporting criterion; and at block 1215, based on the user device handover prediction, performing at least one traffic scheduling operation.

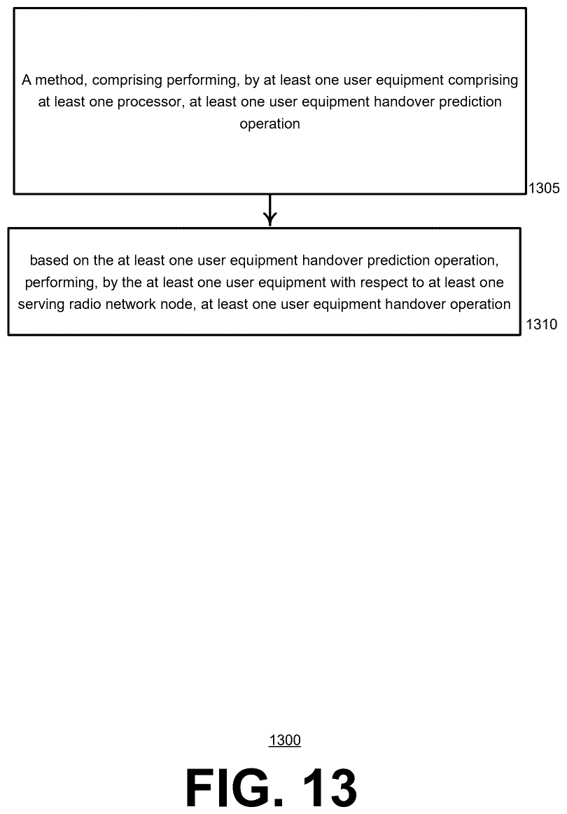

Turning now to FIG. 13, the figure illustrates an example embodiment method 1300 comprising at block 1305 performing, by at least one user equipment comprising at least one processor, at least one user equipment handover prediction operation; and at block 1310, based on the at least one user equipment handover prediction operation, performing, by the at least one user equipment with respect to at least one serving radio network node, at least one user equipment handover operation.

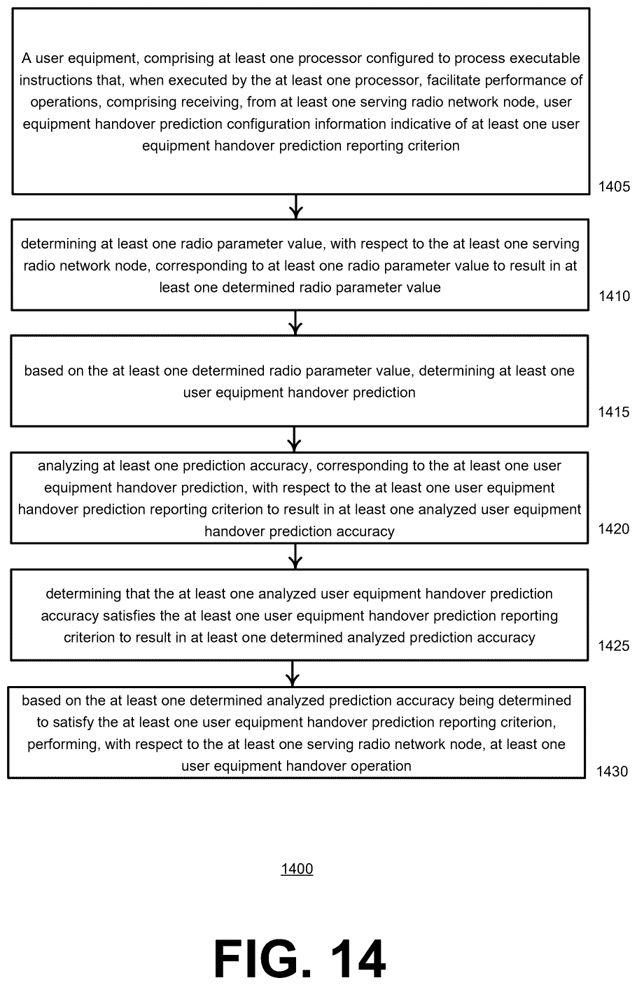

Turning now to FIG. 14, the figure illustrates a user equipment 1400, comprising at block 1405 at least one processor configured to process executable instructions that, when executed by the at least one processor, facilitate performance of operations, comprising receiving, from at least one serving radio network node, user equipment handover prediction configuration information indicative of at least one user equipment handover prediction reporting criterion; at block 1410 determining at least one radio parameter value, with respect to the at least one serving radio network node, corresponding to at least one radio parameter value to result in at least one determined radio parameter value; at block 1415 based on the at least one determined radio parameter value, determining at least one user equipment handover prediction; at block 1420 analyzing at least one prediction accuracy, corresponding to the at least one user equipment handover prediction, with respect to the at least one user equipment handover prediction reporting criterion to result in at least one analyzed user equipment handover prediction accuracy; at block 1425 determining that the at least one analyzed user equipment handover prediction accuracy satisfies the at least one user equipment handover prediction reporting criterion to result in at least one determined analyzed prediction accuracy; and at block 1430, based on the at least one determined analyzed prediction accuracy being determined to satisfy the at least one user equipment handover prediction reporting criterion, performing, with respect to the at least one serving radio network node, at least one user equipment handover operation.

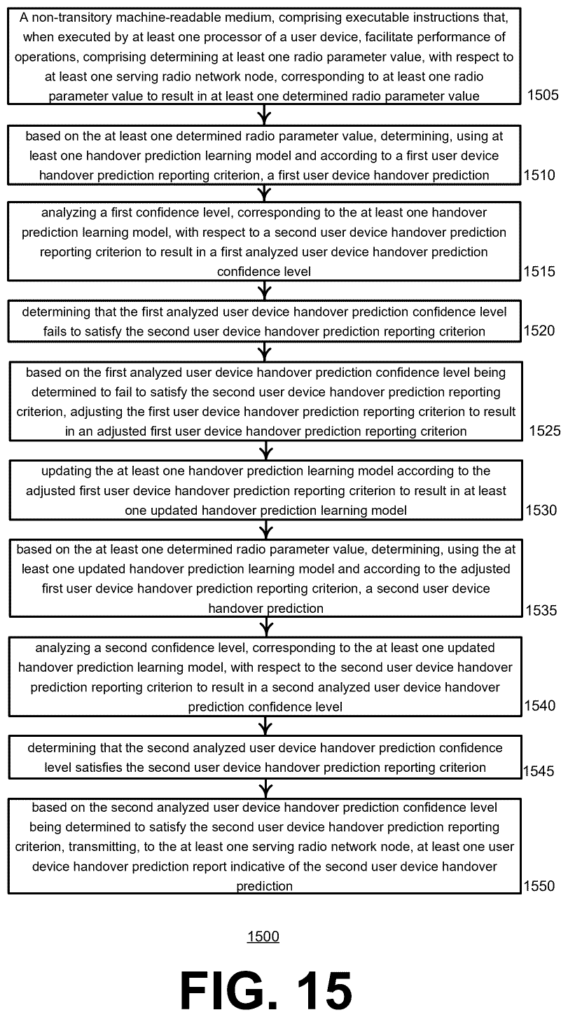

Turning now to FIG. 15, the figure illustrates a non-transitory machine-readable medium 1500 comprising at block 1505 executable instructions that, when executed by at least one processor of a user device, facilitate performance of operations, comprising determining at least one radio parameter value, with respect to at least one serving radio network node, corresponding to at least one radio parameter value to result in at least one determined radio parameter value; at block 1510, based on the at least one determined radio parameter value, determining, using at least one handover prediction learning model and according to a first user device handover prediction reporting criterion, a first user device handover prediction; at block 1515 analyzing a first confidence level, corresponding to the at least one handover prediction learning model, with respect to a second user device handover prediction reporting criterion to result in a first analyzed user device handover prediction confidence level; at block 1520 determining that the first analyzed user device handover prediction confidence level fails to satisfy the second user device handover prediction reporting criterion; at block 1525 based on the first analyzed user device handover prediction confidence level being determined to fail to satisfy the second user device handover prediction reporting criterion, adjusting the first user device handover prediction reporting criterion to result in an adjusted first user device handover prediction reporting criterion; at block 1530 updating the at least one handover prediction learning model according to the adjusted first user device handover prediction reporting criterion to result in at least one updated handover prediction learning model; at block 1535 based on the at least one determined radio parameter value, determining, using the at least one updated handover prediction learning model and according to the adjusted first user device handover prediction reporting criterion, a second user device handover prediction; at block 1540 analyzing a second confidence level, corresponding to the at least one updated handover prediction learning model, with respect to the second user device handover prediction reporting criterion to result in a second analyzed user device handover prediction confidence level; at block 1545 determining that the second analyzed user device handover prediction confidence level satisfies the second user device handover prediction reporting criterion; and at block 1550 based on the second analyzed user device handover prediction confidence level being determined to satisfy the second user device handover prediction reporting criterion, transmitting, to the at least one serving radio network node, at least one user device handover prediction report indicative of the second user device handover prediction.

In order to provide additional context for various embodiments described herein, FIG. 16 and the following discussion are intended to provide a brief, general description of a suitable computing environment 1600 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors and may include a cache memory. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

Computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid-state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an example embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can comprise a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are examples and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning now to FIG. 17, the figure illustrates a block diagram of an example UE 1760. UE 1760 may comprise a smart phone, a wireless tablet, a laptop computer with wireless capability, a wearable device, a machine device that may facilitate vehicle telematics, and the like. UE 1760 comprises a first processor 1730, a second processor 1732, and a shared memory 1734. UE 1760 includes radio front end circuitry 1762, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1762 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 17, UE 1760 may also include a SIM 1764, or a SIM profile, which may comprise information stored in a memory (memory 1734 or a separate memory portion), for facilitating wireless communication with RAN 105 or core network 130 shown in FIG. 1. FIG. 17 shows SIM 1764 as a single component in the shape of a conventional SIM card, but it will be appreciated that SIM 1764 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1764 and another device, which may be a component of RAN 105 or core network 130 shown in FIG. 1). A SIM profile 1764 may also comprise identifying information that is unique to the SIM, or SIM profile, such as, for example, an International Mobile Subscriber Identity (“IMSI”) or information that may make up an IMSI.

SIM 1764 is shown coupled to both the first processor portion 1730 and the second processor portion 1732. Such an implementation may provide an advantage that first processor portion 1730 may not need to request or receive information or data from SIM 1764 that second processor 1732 may request, thus eliminating the use of the first processor acting as a ‘go-between’ when the second processor uses information from the SIM in performing its functions and in executing applications. First processor 1730, which may be a modem processor or baseband processor, is shown smaller than processor 1732, which may be a more sophisticated application processor, to visually indicate the relative levels of sophistication (i.e., processing capability and performance) and corresponding relative levels of operating power consumption levels between the two processor portions. Keeping the second processor portion 1732 asleep/inactive/in a low power state when UE 1760 does not need it for executing applications and processing data related to an application provides an advantage of reducing power consumption when the UE only is going to use the first processor portion 1730 while in listening mode for monitoring routine configured bearer management and mobility management/maintenance procedures, or for monitoring search spaces that the UE has been configured to monitor while the second processor portion remains inactive/asleep.

UE 1760 may also include sensors 1766, such as, for example, temperature sensors, accelerometers, gyroscopes, barometers, moisture sensors, and the like that may provide signals to the first processor 1730 or second processor 1732. Output devices 1768 may comprise, for example, one or more visual displays (e.g., computer monitors, VR appliances, and the like), acoustic transducers, such as speakers or microphones, vibration components, and the like. Output devices 1768 may comprise software that interfaces with output devices, for example, visual displays, speakers, microphones, touch sensation devices, smell or taste devices, and the like, that are external to UE 1760.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a radio network node comprising at least one processor, receiving, from at least one user equipment, at least one user equipment handover prediction report indicative of at least one user equipment handover prediction;
based on the at least one user equipment handover prediction, determining, by the radio network node, pending traffic, associated with a communication session corresponding to the at least one user equipment, that is capable of being delivered, by the radio network node with respect to the at least one user equipment according to the at least one user equipment handover prediction, to result in determined pending traffic; and
facilitating, by the radio network node, delivering the determined pending traffic with respect to the at least one user equipment.

2. The method of claim 1, wherein the at least one user equipment handover prediction is indicative of at least one predicted handover time, predicted by the at least one user equipment, with respect to which a communication link between the at least one user equipment and the radio network node is threshold likely to fail.

3. The method of claim 1, further comprising:
facilitating, by the radio network node, receiving, from the at least one user equipment, at least one user equipment handover prediction capability indication indicative of at least one user equipment handover prediction capability.

4. The method of claim 3, further comprising:
responsive to the receiving of the at least one user equipment handover prediction capability indication, facilitating, by the radio network node, transmitting, to the at least one user equipment, user equipment handover prediction configuration information indicative of at least one user equipment handover prediction reporting criterion.

5. The method of claim 4, wherein the user equipment handover prediction configuration information comprises at least one of: at least one handover prediction learning model confidence level criterion to be usable by the at least one user equipment to determine whether to transmit the at least one user equipment handover prediction report; or at least one preferred handover prediction reporting time indication indicative of at least one time with respect to which transmitting of the at least one user equipment handover prediction report is to be performed.

6. The method of claim 5, wherein the at least one user equipment handover prediction is indicative of at least one predicted handover time, predicted by the at least one user equipment, with respect to which a communication link between the at least one user equipment and the radio network node is threshold likely to fail, and wherein the at least one predicted handover time is earlier than the at least one time.

7. The method of claim 1, wherein the determining of the determined pending traffic comprises:
analyzing at least one predicted handover time, indicated by the at least one user equipment handover prediction and with respect to which a communication link between the at least one user equipment and the radio network node is threshold likely to fail, with respect to at least one remaining latency budget associated with the pending traffic, to result in at least one analyzed predicted handover time; and
determining that the at least one analyzed predicted handover time occurs after at least one scheduled delivery time with respect to which at least a portion of the pending traffic has been scheduled to be delivered,
wherein the facilitating of the delivering of the determined pending traffic with respect to the at least one user equipment comprises:
based on the at least one analyzed predicted handover time being determined to occur after the at least one scheduled delivery time, facilitating the delivering of the determined pending traffic with respect to the at least one user equipment before the at least one predicted handover time.

8. The method of claim 7, wherein the at least one scheduled delivery time is at least one first scheduled delivery time,
wherein the method further comprises:
determining, by the radio network node, a second scheduled delivery time that occurs earlier than the at least one first scheduled delivery time, and
wherein the facilitating of the delivering of the determined pending traffic with respect to the at least one user equipment before the at least one predicted handover time comprises facilitating the delivering of the determined pending traffic with respect to the at least one user equipment at least as early as the second scheduled delivery time.

9. The method of claim 1, wherein the determining of the determined pending traffic comprises:
analyzing the at least one predicted handover time, indicated by the at least one user equipment handover prediction and with respect to which a communication link between the at least one user equipment and the radio network node is threshold likely to fail, with respect to at least one remaining latency budget associated with the pending traffic, to result in at least one analyzed predicted handover time; and
determining that the at least one analyzed predicted handover time occurs before at least one scheduled delivery time with respect to which at least a portion of the pending traffic has been scheduled to be delivered,
wherein the facilitating of the delivering of the determined pending traffic with respect to the at least one user equipment comprises:
based on the at least one analyzed predicted handover time being determined to occur earlier than the at least one scheduled delivery time, facilitating the delivering of the determined pending traffic with respect to the at least one user equipment before the at least one predicted handover time.

10. The method of claim 1, wherein the radio network node is a serving radio network node, wherein the at least one user equipment handover prediction report is further indicative of at least one target radio network node, determined by the at least one user equipment, and wherein the method further comprises:
after the delivering of the determined pending traffic with respect to the at least one user equipment, facilitating, by the serving radio network node, performing at least one handover operation corresponding to the at least one user equipment and with respect to the at least one target radio network node.

11. A radio network node, comprising at least one processor configured to process executable instructions that, when executed by the at least one processor, facilitate performance of operations, comprising:
receiving, from at least one user equipment, at least one user equipment handover prediction capability indication indicative of at least one user equipment handover prediction capability;
responsive to the at least one user equipment handover prediction capability, determining user equipment handover prediction configuration information indicative of at least one user equipment handover prediction reporting criterion;
transmitting, to the at least one user equipment, the user equipment handover prediction configuration information;
receiving, from the at least one user equipment, at least one user equipment handover prediction report indicative of at least one user equipment handover prediction, wherein the at least one user equipment handover prediction is determined by the at least one user equipment based on the user equipment handover prediction configuration information; and
based on the at least one user equipment handover prediction, performing at least one traffic scheduling operation.

12. The radio network node of claim 11, wherein the performing of the at least one traffic scheduling operation comprises:
determining at least one remaining delay budget associated with at least one protocol data unit corresponding to pending traffic to be directed to the at least one user equipment to result in at least one determined remaining delay budget;
analyzing the at least one determined remaining delay budget with respect to the at least one user equipment handover prediction to result in at least one analyzed determined remaining delay budget;
determining that the at least one analyzed determined remaining delay budget is associated with at least one remaining delay budget exhaustion time that occurs before at least one predicted handover time indicated by the at least one user equipment handover prediction; and
avoiding changing a current scheduling of delivery of the at least one protocol data unit.

13. The radio network node of claim 11, wherein the performing of the at least one traffic scheduling operation comprises:
determining at least one remaining delay budget associated with at least one protocol data unit corresponding to pending traffic to be directed to the at least one user equipment to result in at least one determined remaining delay budget;
analyzing the at least one determined remaining delay budget with respect to the at least one user equipment handover prediction to result in at least one analyzed determined remaining delay budget;
determining that the at least one analyzed determined remaining delay budget is associated with at least one remaining delay budget exhaustion time that occurs before at least one predicted handover time indicated by the at least one user equipment handover prediction; and
adjusting a current scheduling of delivery of the at least one protocol data unit to result in an adjusted scheduling of delivery of the at least one protocol data unit, wherein the adjusted scheduling corresponds to an earlier delivering of the at least one protocol data unit as compared to delivering the at least one protocol data unit according to the current scheduling.

14. The radio network node of claim 13, wherein the at least one user equipment handover prediction reporting criterion comprises at least one preferred handover prediction reporting time indication indicative of at least one preferred handover prediction reporting time with respect to which the at least one user equipment is to transmit the at least one user equipment handover prediction report relative to the at least one predicted handover time indicated by the at least one user equipment handover prediction, and wherein a prediction reporting difference between a prediction receiving time corresponding to the receiving the at least one user equipment handover prediction report and the at least one predicted handover time is smaller than the at least one preferred handover prediction reporting time.

15. The radio network node of claim 11, wherein the performing of the at least one traffic scheduling operation comprises determining at least one scheduling of at least one protocol data unit corresponding to traffic to be directed to the at least one user equipment, and wherein the operations further comprise:
delivering the traffic with respect to the at least one user equipment according to the at least one scheduling.

16. A non-transitory machine-readable medium, comprising executable instructions that, when executed by at least one processor of radio network equipment, facilitate performance of operations, comprising:
transmitting, to a user device, user device handover prediction configuration information that is based on at least one user device handover prediction capability and that comprises criterion information representative of at least one user device handover prediction reporting criterion;
receiving, from the user device, a user device handover prediction report indicative of a user device handover prediction, wherein the user device handover prediction is determined by the user device based on at least one user device handover prediction reporting criterion; and
based on the user device handover prediction, performing at least one traffic scheduling operation.

17. The non-transitory machine-readable medium of claim 16, wherein the performing of the at least one traffic scheduling operation comprises:
determining a remaining delay budget associated with a traffic packet to be directed to the user device to result in a determined remaining delay budget;
analyzing the determined remaining delay budget with respect to the user device handover prediction to result in an analyzed determined remaining delay budget;
determining that the analyzed determined remaining delay budget is associated with a remaining delay budget exhaustion time that will occur before a predicted handover time indicated by the user device handover prediction; and
avoiding changing a current scheduling of delivery of the traffic packet.

18. The non-transitory machine-readable medium of claim 16, wherein the performing of the at least one traffic scheduling operation comprises:
determining a remaining delay budget associated with a traffic packet to be directed to the user device to result in a determined remaining delay budget;
analyzing the determined remaining delay budget with respect to the user device handover prediction to result in an analyzed determined remaining delay budget;
determining that the analyzed determined remaining delay budget is associated with a remaining delay budget exhaustion time that will occur before a predicted handover time indicated by the user device handover prediction; and
adjusting a current scheduling of delivery of the traffic packet to result in an adjusted scheduling of delivery of the traffic packet, wherein the adjusted scheduling corresponds to delivering the traffic packet earlier than delivering the traffic packet according to the current scheduling.

19. The non-transitory machine-readable medium of claim 16, wherein the performing of the at least one traffic scheduling operation comprises:
determining a remaining delay budget associated with a traffic packet to be directed to the user device to result in a determined remaining delay budget;
analyzing the determined remaining delay budget with respect to the user device handover prediction to result in an analyzed determined remaining delay budget; and
determining that the analyzed determined remaining delay budget is associated with a remaining delay budget exhaustion time that will occur after a predicted handover time indicated by the user device handover prediction, and
wherein the operations further comprise:
initiating handover of the user device to a target radio network node; and
forwarding the traffic packet to the target radio network node for transmission thereby to the user device.

20. The non-transitory machine-readable medium of claim 19, wherein the target radio network node is indicated by the user device handover prediction report.
